(19) United States
(12) Patent Application Publication
(10) Pub. No.: US 2011/0198988 A1
(43) Pub. Date: Aug. 18, 2011

(54) ORGANOMETALLIC COMPLEX AND LIGHT-EMITTING ELEMENT, LIGHTING DEVICE, AND ELECTRONIC DEVICE INCLUDING THE ORGANOMETALLIC COMPLEX

(75) Inventors: Hideko INOUE, Atsugi (JP); Tomoka NAKAGAWA, Atsugi (JP); Satoshi SEO, Sagamihara (JP)

(73) Assignee: SEMICONDUCTOR ENERGY LABORATORY CO., LTD., Atsugi (JP)

(21) Appl. No.: 13/024,570

(22) Filed: Feb. 10, 2011

(30) Foreign Application Priority Data
Feb. 16, 2010 (JP) 2010-031027

(51) Int. Cl. H01J 1/62; C07F 15/00

(52) U.S. Cl. 313/504; 548/103

(57) ABSTRACT

A first object is to provide an organometallic complex capable of exhibiting phosphorescence. In General Formula (G1), at least one substituent of R¹¹ to R¹⁴ represents any of a halogen group, a haloalkyl group having 1 to 4 carbon atoms, and a cyano group. At least one substituent of R¹⁵ to R¹⁹ represents any of a halogen group, a haloalkyl group having 1 to 4 carbon atoms, and a cyano group. R²⁰ represents any of an alkyl group having 1 to 6 carbon atoms, a cycloalkyl group having 5 to 8 carbon atoms, an aryl group having 6 to 12 carbon atoms, and a heteroaryl group having 4 to 10 carbon atoms. M is either a Group 9 element or a Group 10 element. When M is a Group 9 element, n is 3, and when M is a Group 10 element, n is 2.

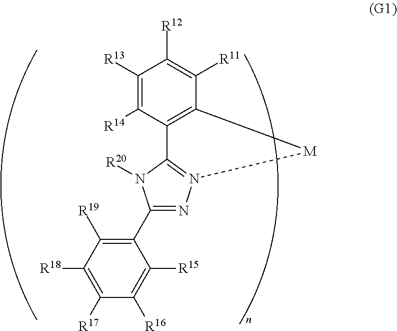

### BACKGROUND OF THE INVENTION

1. Field of the Invention

The present invention relates to organometallic complexes. The present invention further relates to light-emitting elements, lighting devices, and electronic devices which include the organometallic complexes.

2. Description of the Related Art

Patent Document 1, for example, discloses a substance which emits light by current excitation. In particular, an organometallic complex emitting light having a wavelength band of green to blue is disclosed as a phosphorescent material.

### REFERENCE

### Patent Document

[Patent Document 1] Japanese Published Patent Application No. 2007-137872

As said in Patent Document 1, however, there have not been many reports on phosphorescent materials emitting green to blue light, although the development of them is progressing. Among the phosphorescent materials emitting green to blue light, for example, it is known that Ir complexes where 2-phenylpyridine and a derivative thereof are ligands emit light having a wavelength band of green to blue. However, holes are easy to inject but electrons are difficult to inject into such phosphorescent materials; thus, there are limitations on structures of light-emitting elements including the phosphorescent materials. Moreover, the phosphorescent materials also have a problem of poor heat resistance, which can be said for the overall organometallic complexes.

Therefore, in the case of applying phosphorescent materials to light-emitting elements, it has been required to develop various phosphorescent materials which emit light having a wavelength band of green to blue so that the phosphorescent materials can be used in combination with various peripheral materials such as a host material, a hole-transport material, and an electron-transport material. In addition, it has been required to develop phosphorescent materials which emit green to blue light and have high heat resistance. That is, development of phosphorescent materials which have higher reliability and more excellent light-emitting property, and which can be manufactured at lower cost is demanded.

If a novel organometallic complex that emits light having a wider wavelength band of green to blue than ever can be provided, a light-emitting element with a higher color rendering property than ever can be provided. For example, in the case of using organometallic complexes in a lighting device which produces white light with two light sources which emit light of different colors from each other, it is preferable that an organometallic complex which exhibits a wider emission spectrum than a conventional organometallic complex be used in either light source because the color rendering property becomes higher. In addition, without limitation to the light-emitting element which produces white light with two light sources which emit light of different colors from each other, light-emitting elements having other structures with a higher color rendering property can be manufactured.

### SUMMARY OF THE INVENTION

In view of the above description, objects of the present invention are as follows.

A first object is to provide an organometallic complex capable of exhibiting phosphorescence.

A second object is to provide a novel organometallic complex that is capable of emitting light in a wider wavelength band of green to blue.

A third object is to provide a novel organometallic complex which exhibits phosphorescence and which has high heat resistance.

A fourth object is to provide a novel organometallic complex which exhibits emission in a wavelength band of green to blue and which has a high yield in the synthesis process.

A fifth object is to provide a light-emitting element including any of the above organometallic complexes.

A sixth object is to provide a display device, a lighting device, a light-emitting device, and an electronic device each including the above light-emitting element.

Note that at least one of the first to sixth objects may be achieved.

An organometallic complex having a wider emission spectrum in a wavelength band of green to blue than conventional organometallic complexes is described below.

One embodiment of the present invention is an organometallic complex having a structure represented by General Formula (G1).

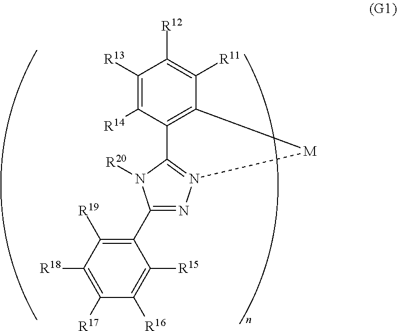

In General Formula (G1), at least one substituent of R¹¹ to R¹⁴ represents any of a halogen group, a haloalkyl group having 1 to 4 carbon atoms, and a cyano group. At least one substituent of R¹⁵ to R¹⁹ represents any of a halogen group, a haloalkyl group having 1 to 4 carbon atoms, and a cyano group. The other substituents separately represent any of hydrogen, an alkyl group having 1 to 6 carbon atoms, a cycloalkyl group having 5 to 8 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, an alkylamino group having 2 to 8 carbon atoms, an arylamino group having 6 to 12 carbon atoms, a halogen group, a haloalkyl group having 1 to 4 carbon atoms, an aryl group having 6 to 12 carbon atoms, and a cyano group. In addition, R²⁰ represents any of an alkyl group having 1 to 6 carbon atoms, a cycloalkyl group having 5 to 8 carbon atoms, an aryl group having 6 to 12 carbon atoms, and a heteroaryl group having 4 to 10 carbon atoms. M is either a Group 9 element or a Group 10 element. When M is a Group 9 element, n is 3, and when M is a Group 10 element, n is 2.

Specific examples of the halogen group in any of R¹¹ to R¹⁴ and R¹⁵ to R¹⁹ are a fluoro group, a chloro group, a bromo group, and an iodine group. Specific examples of the haloalkyl group having 1 to 4 carbon atoms are a fluoromethyl group, a difluoromethyl group, a difluorochloromethyl group, a trifluoromethyl group, a chloromethyl group, a dichloromethyl group, a bromomethyl group, a 2,2,2-trifluoroethyl group, a pentafluoroethyl group, a 3,3,3-trifluoropropyl group, a 1,1,1,3,3,3-hexafluoroisopropyl group, and the like. Specific examples of R²⁰ are a methyl group, an ethyl group, a propyl group, an isopropyl group, a tert-butyl group, an isobutyl group, a hexyl group, a cyclohexyl group, a 1-methylcyclohexyl group, a 2,6-dimethylcyclohexyl group, a 2,6-dimethylphenyl group, a 4-tert-butylphenyl group, a biphenyl group, a naphthyl group, a thienyl group, a furyl group, a benzothienyl group, a benzofuryl group, a pyridyl group, a quinolyl group, a pyrazyl group, a quinoxalyl group, a benzoxazolyl group, a benzimidazolyl group, a benzotriazolyl group, and the like.

Note that in the organometallic complex having the structure represented by General Formula (G1) above, as in an organometallic complex represented by General Formula (G2) below, specifically, iridium is more preferable as the central metal in view of emission efficiency and heat resistance.

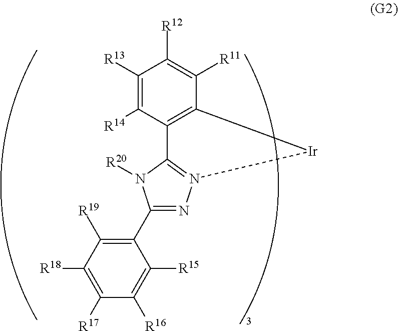

In General Formula (G2), at least one substituent of R¹¹ to R¹⁴ represents any of a halogen group, a haloalkyl group having 1 to 4 carbon atoms, and a cyano group. At least one substituent of R¹⁵ to R¹⁹ represents any of a halogen group, a haloalkyl group having 1 to 4 carbon atoms, and a cyano group. The other substituents separately represent any of hydrogen, an alkyl group having 1 to 6 carbon atoms, a cycloalkyl group having 5 to 8 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, an alkylamino group having 2 to 8 carbon atoms, an arylamino group having 6 to 12 carbon atoms, a halogen group, a haloalkyl group having 1 to 4 carbon atoms, an aryl group having 6 to 12 carbon atoms, and a cyano group. In addition, R²⁰ represents any of an alkyl group having 1 to 6 carbon atoms, a cycloalkyl group having 5 to 8 carbon atoms, an aryl group having 6 to 12 carbon atoms, and a heteroaryl group having 4 to 10 carbon atoms.

Here, specifically, the organometallic complex having the structure represented by General Formula (G1) above is preferably an organometallic complex represented by General Formula (G3) below because the synthesis is easy.

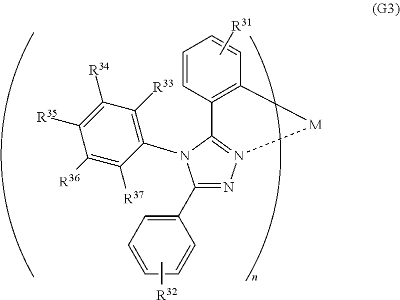

In General Formula (G3), R³¹ and R³² separately represent any of a halogen group, a haloalkyl group having 1 to 4 carbon atoms, and a cyano group. In addition, R³³ to R³⁷ separately represent any of hydrogen, an alkyl group having 1 to 6 carbon atoms, a cycloalkyl group having 5 to 8 carbon atoms, and a phenyl group. M is either a Group 9 element or a Group 10 element. When M is a Group 9 element, n is 3, and when M is a Group 10 element, n is 2. Note that R³¹ represents a substituent bonded to any of the 3-, 4-, 5-, and 6-positions of a benzene ring that is bonded. Note also that R³² represents a substituent bonded to any of the 2-, 3-, 4-, 5-, and 6-positions of a benzene ring that is bonded.

Here, specifically, the organometallic complex having the structure represented by General Formula (G2) above is preferably an organometallic complex represented by General Formula (G4) below because the synthesis is easy.

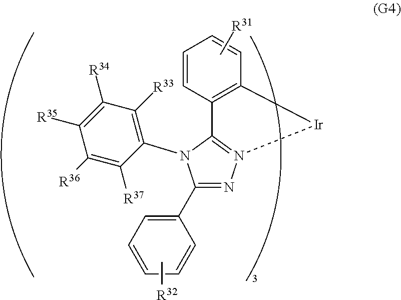

In General Formula (G4), R³¹ and R³² separately represent any of a halogen group, a haloalkyl group having 1 to 4 carbon atoms, and a cyano group. Alternatively, R³¹ and R³² separately represent an electron-withdrawing group. In addition, R³³ to R³⁷ separately represent any of hydrogen, an alkyl group having 1 to 6 carbon atoms, a cycloalkyl group having 5 to 8 carbon atoms, and a phenyl group.

Here, specifically, the organometallic complex having the structure represented by General Formula (G3) above is preferably an organometallic complex represented by General Formula (G5) below because the synthesis is easy.

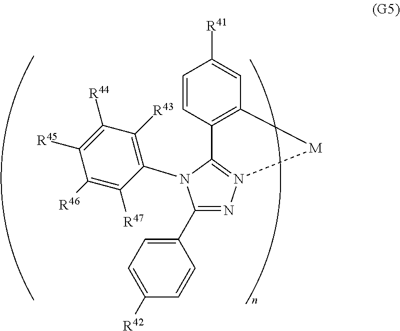

In General Formula (G5), R⁴¹ and R⁴² separately represent any of a halogen group, a haloalkyl group having 1 to 4 carbon atoms, and a cyano group. Alternatively, R⁴¹ and R⁴² separately represent an electron-withdrawing group. In addition, R⁴³ to R⁴⁷ separately represent any of hydrogen, an alkyl group having 1 to 6 carbon atoms, a cycloalkyl group having 5 to 8 carbon atoms, and a phenyl group. M is either a Group 9 element or a Group 10 element. When M is a Group 9 element, n is 3, and when M is a Group 10 element, n is 2.

Here, specifically, the organometallic complex having the structure represented by General Formula (G4) above is preferably an organometallic complex represented by General Formula (G6) below because the synthesis is easy.

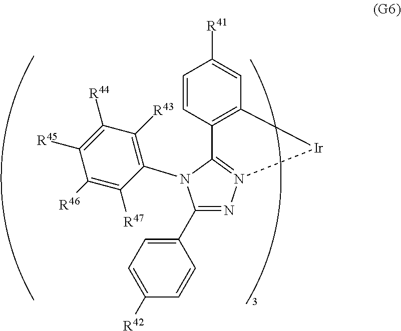

In General Formula (G6), R⁴¹ and R⁴² separately represent any of a halogen group, a haloalkyl group having 1 to 4 carbon atoms, and a cyano group. Alternatively, R⁴¹ and R⁴² separately represent an electron-withdrawing group. In addition, R⁴³ to R⁴⁷ separately represent any of hydrogen, an alkyl group having 1 to 6 carbon atoms, a cycloalkyl group having 5 to 8 carbon atoms, and a phenyl group.

One embodiment of the present invention is an organometallic complex in General Formulas (G3) and (G4) in which R³¹ and R³² are fluoro groups.

Another embodiment of the present invention is an organometallic complex in General Formulas (G5) and (G6) in which R⁴¹ and R⁴² are fluoro groups.

Another embodiment of the present invention is a light-emitting element including a layer that contains any of the above organometallic complexes between electrodes.

Another embodiment of the present invention is a light-emitting element including any of the above organometallic complexes as a light-emitting substance.

Another embodiment of the present invention is a light-emitting device in which any of the above light-emitting elements is used as a pixel or a light source.

Another embodiment of the present invention is an electronic device including the above light-emitting device in a display portion.

Note that the organometallic complex which is one embodiment of the present invention can be used in combination with a fluorescent material and can also be used for usage of increasing emission efficiency of the fluorescent material. In other words, in the light-emitting element, the organometallic complex can also be used as a sensitizer for the fluorescent material.

When the light-emitting element is used in a light-emitting device, the color rendering property of light emission of the light-emitting element becomes a concern. The organometallic complex which is one embodiment of the present invention exhibits a broad emission spectrum and light of the entire visible light region is emitted; thus, the color rendering property is high and the light emission can be close to natural light accordingly.

In particular, when the light-emitting element is used in a lighting device, the color rendering property of light emission of the light-emitting element becomes a concern. When a plurality of light-emitting materials each of which exhibits a sharp emission spectrum are used in a white light-emitting element, the color rendering property becomes low. In contrast, when the organometallic complex which is one embodiment of the present invention and which exhibits a broad emission spectrum is used, light of the entire visible light region is emitted; thus, the color rendering property becomes high and the light emission can be close to natural light accordingly.

In this specification, a “light-emitting device” means general devices each having a light-emitting element; specifically, it includes in its category a backlight used in a display device such as a television or a mobile phone, a traffic light, a lighting application such as a streetlight or illuminations on the street, a lighting device, lighting for breeding that can be used in a plastic greenhouse, and the like.

With one embodiment of the present invention, a novel substance capable of exhibiting phosphorescence can be provided.

By using the organometallic complex which is one embodiment of the present invention as a light-emitting substance, a high-efficiency light-emitting element that can emit green to blue light can be obtained. Further, white light can be easily produced by using the organometallic complex which is one embodiment of the present invention and another light-emitting material which emits red to yellow light, i.e., light of a complementary color.

When a light-emitting element where the organometallic complex which is one embodiment of the present invention and another light-emitting material which emits red to yellow light is used for manufacturing a light-emitting device such as a display device or a lighting device, a light-emitting device such as a display device or a lighting device emits white light that is closer to natural light, in other words, white light that has a higher color rendering property, than a light-emitting device including a conventional substance which emits light having a wavelength band of green to blue (e.g., a substance described in Patent Document 1) and the like.

With one embodiment of the present invention, an organometallic complex capable of exhibiting phosphorescence can be obtained. In particular, an organometallic complex exhibiting phosphorescence having a wavelength band of green to blue can be obtained. In addition, an organometallic complex which exhibits phosphorescence and which has high heat resistance can be obtained. Moreover, with one embodiment of the present invention, an organometallic complex that can be used as a sensitizer can be obtained.

### BRIEF DESCRIPTION OF THE DRAWINGS

FIGS. 1A and 1B show light-emitting elements each of which is one embodiment of the present invention.

FIGS. 2A to 2D show a light-emitting device to which the present invention is applied.

FIG. 3 shows a circuit included in a light-emitting device to which the present invention is applied.

FIGS. 4A and 4B show a light-emitting device to which the present invention is applied.

FIGS. 5A to 5E show electronic devices and lighting devices to which the present invention is applied.

FIG. 6 shows electronic devices to which the present invention is applied.

FIG. 7 shows a display device to which the present invention is applied.

FIG. 8 shows a ¹H-NMR chart of an organometallic complex [Ir(Ftaz)₃] synthesized in Example 1.

FIG. 9 shows an ultraviolet-visible light absorption spectrum and an emission spectrum of the organometallic complex [Ir(Ftaz)₃] which is one embodiment of the present invention in a dichloromethane solution.

FIG. 10 shows a ¹H-NMR chart of an organometallic complex [Ir(taz-dmp)₃] synthesized in Comparative Example 1.

FIG. 11 shows an ultraviolet-visible light absorption spectrum and an emission spectrum of the organometallic complex [Ir(taz-dmp)₃] in a dichloromethane solution.

FIG. 12 shows a ¹H-NMR chart of an organometallic complex [Ir(tButaz)₃] synthesized in Comparative Example 2.

FIG. 13 shows an ultraviolet-visible light absorption spectrum and an emission spectrum of the organometallic complex [Ir(tButaz)₃] in a dichloromethane solution.

FIG. 14 shows a ¹H-NMR chart of an organometallic complex [Ir(Ftaz)₂(acac)] synthesized in Comparative Example 3.

FIG. 15 shows an ultraviolet-visible light absorption spectrum and an emission spectrum of the organometallic complex [Ir(Ftaz)₂(acac)] in a dichloromethane solution.

FIG. 16 shows comparison between emission spectra of [Ir(Ftaz)₃], [Ir(tButaz)₃], and [Ir(Ftaz)₂(acac)].

FIG. 17 shows an emission spectrum of Light-emitting Element 1.

FIG. 18 shows voltage vs. luminance characteristics of Light-emitting Element 1.

FIG. 19 shows current density vs. luminance characteristics of Light-emitting Element 1.

### DETAILED DESCRIPTION OF THE INVENTION

Hereinafter, embodiments of the present invention will be described with reference to the accompanying drawings. However, the present invention can be carried out in many different modes, and it is easily understood by those skilled in the art that modes and details of the present invention can be modified in various ways without departing from the purpose and the scope of the present invention. Therefore, the present invention should not be construed as being limited to the following description of the embodiments.

Of a pair of electrodes of a light-emitting element in the present invention, an electrode that serves as an anode means an electrode which has a higher potential when voltage is applied so that light emission is obtained, and an electrode that serves as a cathode means an electrode which has a lower potential when voltage is applied so that light emission is obtained.

In this specification, the phrase “A and B are connected” means the case where A and B are electrically connected (i.e., A and B are connected with another element or circuit interposed therebetween), the case where A and B are functionally connected (i.e., A and B are functionally connected with another circuit interposed therebetween), or the case where A and B are directly connected (i.e., A and B are connected without another element or circuit interposed therebetween).

### Embodiment 1

In this embodiment, organometallic complexes each of which is one embodiment of the present invention will be described. An organometallic complex including a structure which is represented by General Formula (G1) below is one embodiment of the present invention.

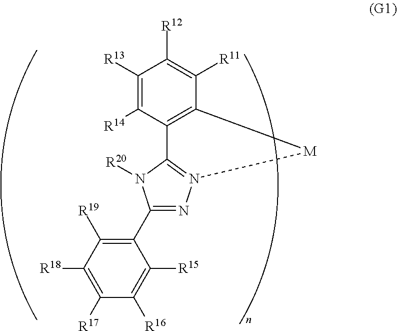

In General Formula (G1), at least one substituent of R¹¹ to R¹⁴ represents any of a halogen group, a haloalkyl group having 1 to 4 carbon atoms, and a cyano group. At least one substituent of R¹⁵ to R¹⁹ represents any of a halogen group, a haloalkyl group having 1 to 4 carbon atoms, and a cyano group. The other substituents separately represent any of hydrogen, an alkyl group having 1 to 6 carbon atoms, a cycloalkyl group having 5 to 8 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, an alkylamino group having 2 to 8 carbon atoms, an arylamino group having 6 to 12 carbon atoms, a halogen group, a haloalkyl group having 1 to 4 carbon atoms, an aryl group having 6 to 12 carbon atoms, and a cyano group. In addition, R²⁰ represents any of an alkyl group having 1 to 6 carbon atoms, a cycloalkyl group having 5 to 8 carbon atoms, an aryl group having 6 to 12 carbon atoms, and a heteroaryl group having 4 to 10 carbon atoms. M is either a Group 9 element or a Group 10 element. When M is a Group 9 element, n is 3, and when M is a Group 10 element, n is 2.

Specific examples of organometallic complexes having the structure represented by General Formula (G1) can be organometallic complexes represented by Structural Formulas (100) to (139). However, the present invention is not limited to the description here.

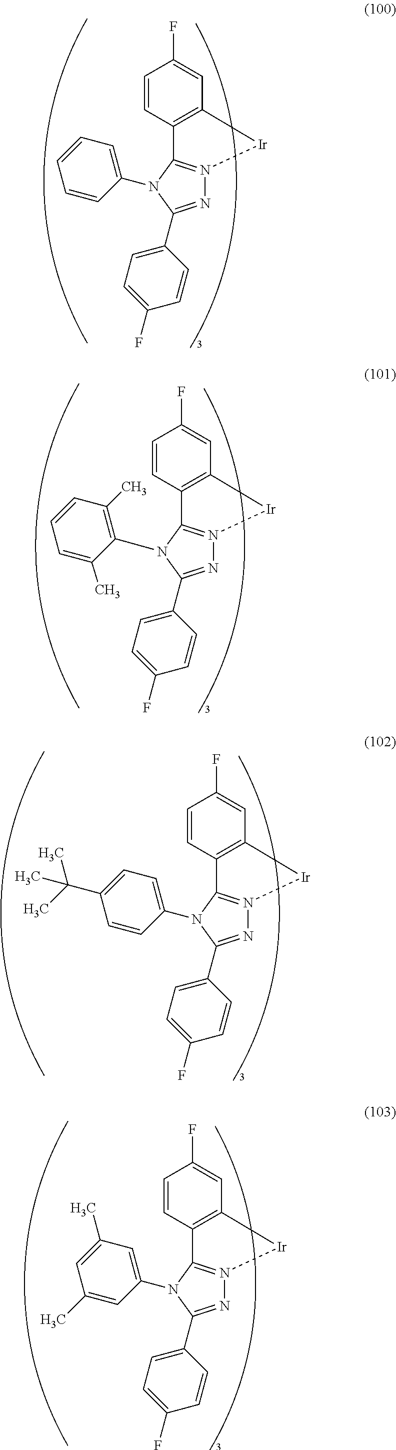

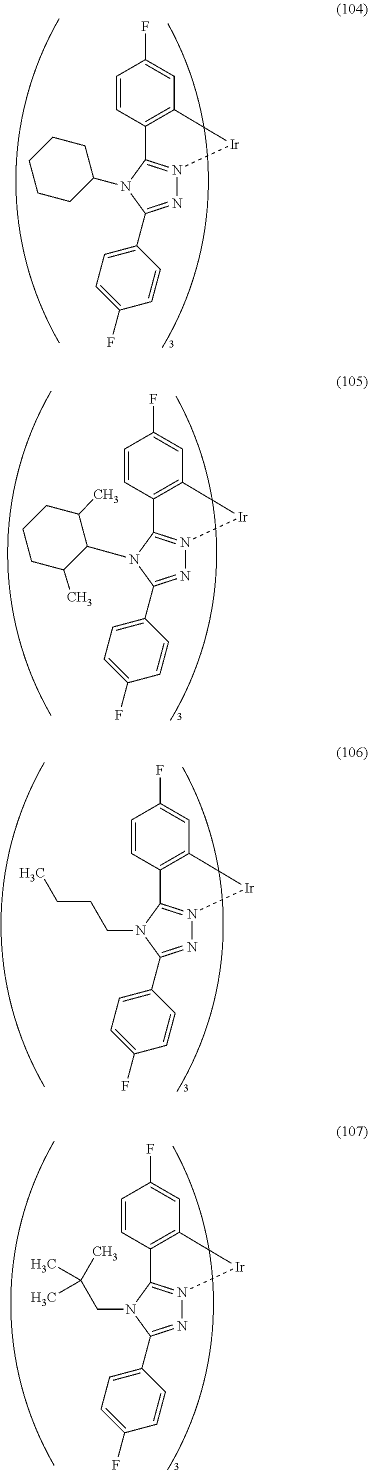

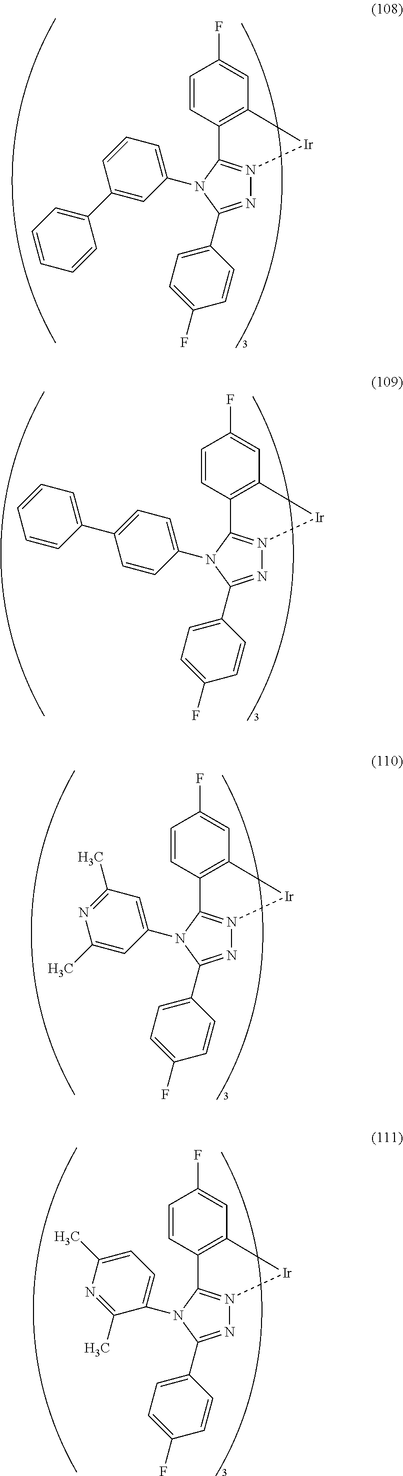

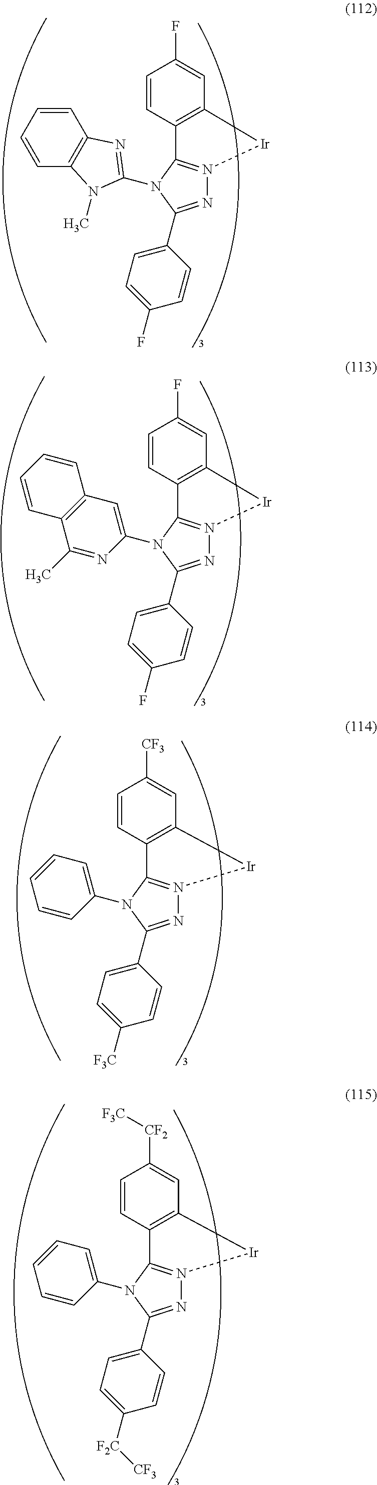

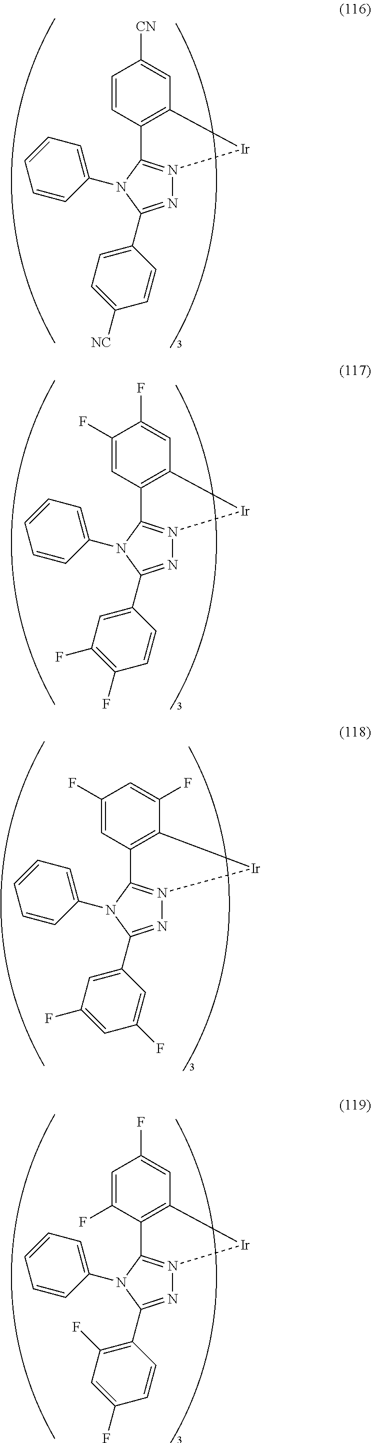

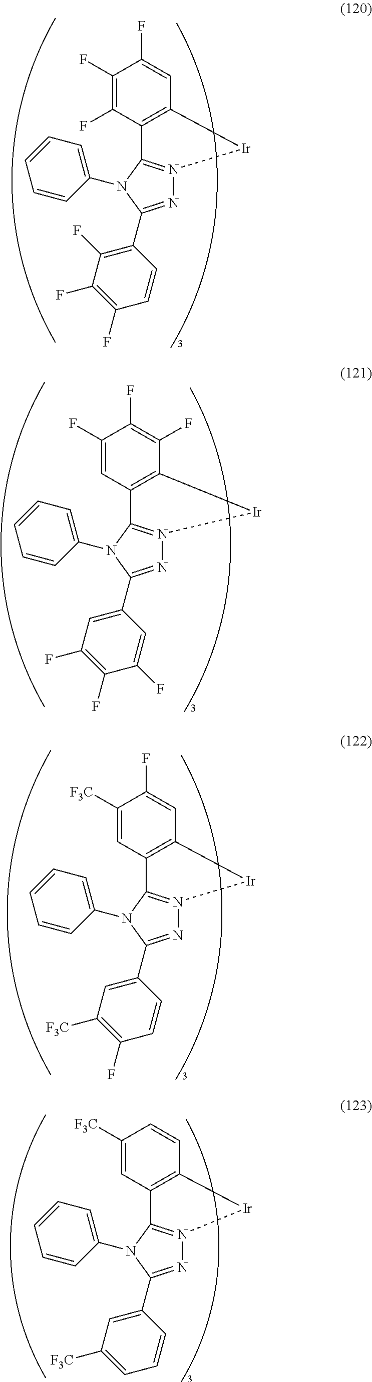

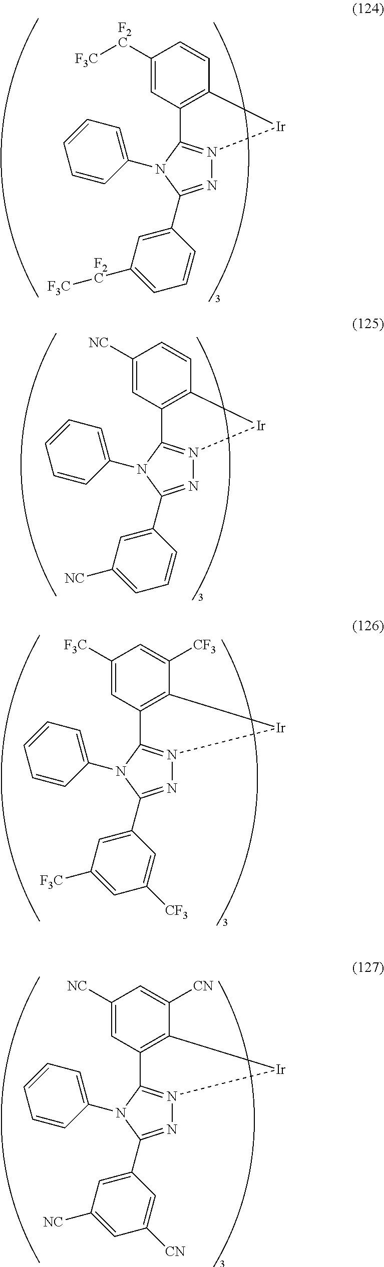

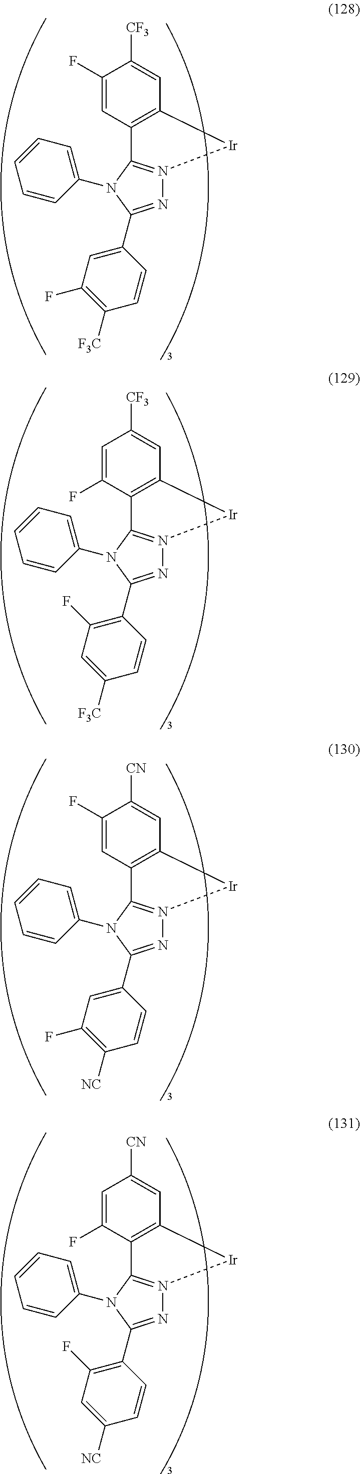

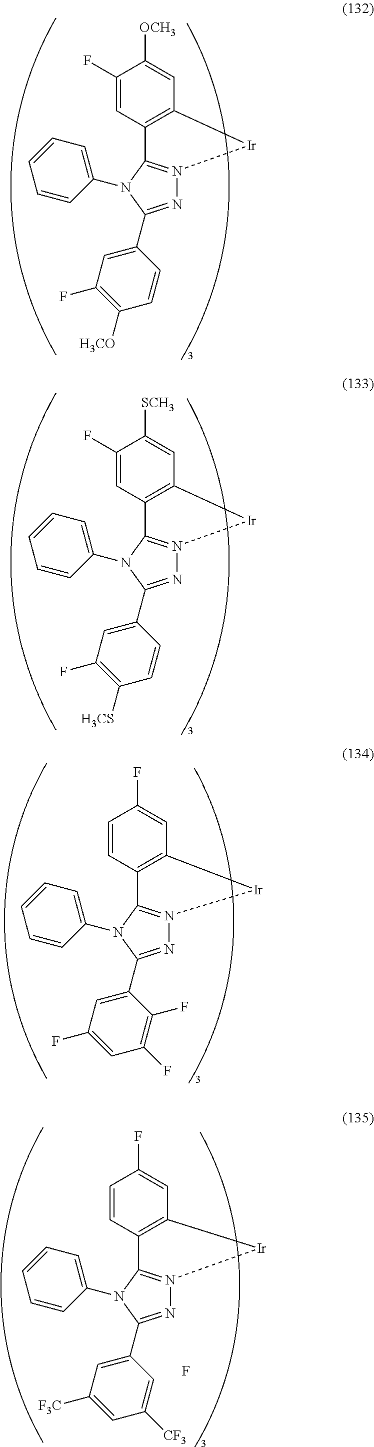

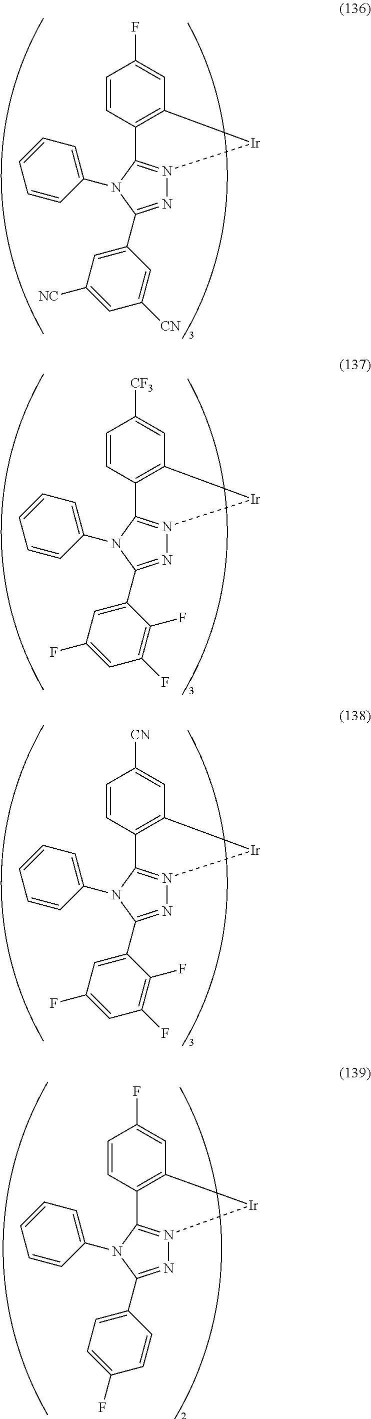

The above-described organometallic complexes each of which is one embodiment of the present invention are novel substances that can exhibit phosphorescence.

Next, an example of a synthesis method of an organometallic complex having the structure represented by General Formula (G1) is described.

### A Synthesis Method of a 4H-1,2,4-triazole Derivative Represented by General Formula (G0)

A 4H-1,2,4-triazole derivative represented by General Formula (G0) below can be synthesized according to a simple synthesis scheme below. For example, as shown in a scheme (a) below, an aryl aldazine derivative (A2) is obtained by substituting two oxygen atoms of a diaroyl hydrazine derivative (A1) with two chlorine atoms using a chlorizing agent such as phosphorus pentachloride, and then it is heated together with a primary amine (A3) so that ring closure is performed; thus, the 4H-1,2,4-triazole derivative is prepared.

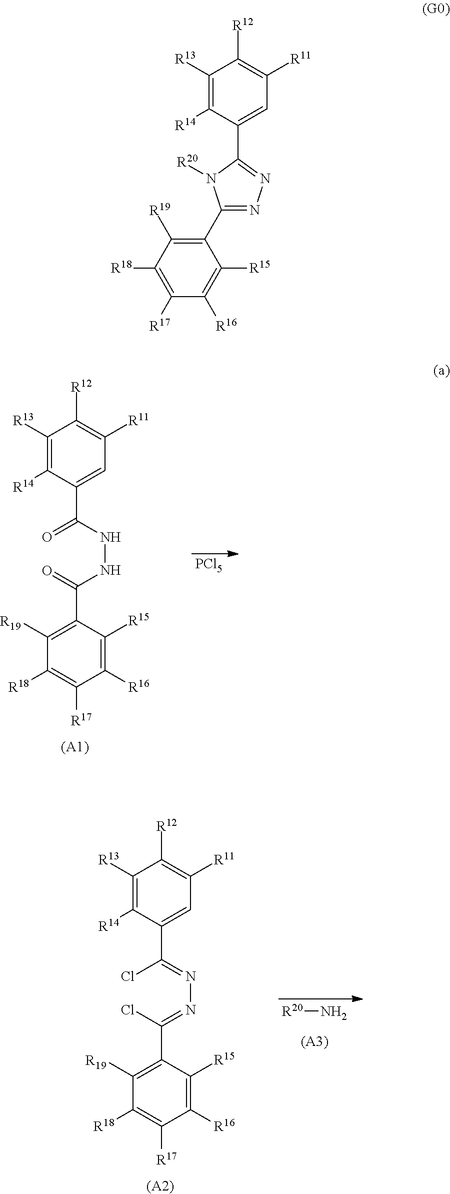

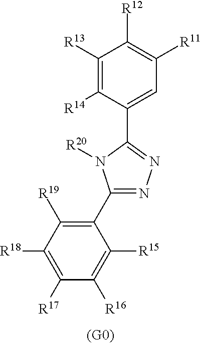

Since various kinds of the above-described compounds (A1), (A2), and (A3) are commercially available or can be synthesized, many kinds of 4H-1,2,4-triazole derivatives represented by General Formula (G0) can be synthesized. Thus, a feature of the organometallic complex which is one embodiment of the present invention is the abundance of ligand variations.

### A Synthesis Method of an Organometallic Complex which is One Embodiment of the Present Invention Represented by General Formula (G1)

Next, an organometallic complex which is one embodiment of the present invention and which is prepared by ortho-metallating the 4H-1,2,4-triazole derivative represented by General Formula (G0), in other words, an organometallic complex having the structure represented by General Formula (G1), is described.

First, as shown in a synthesis scheme (b) below, the 4H-1,2,4-triaozle derivative represented by General Formula (G0) and MZ (a metal compound of a Group 9 element or a Group 10 element containing a halogen, or an organic complex compound of a Group 9 element or a Group 10 element containing a halogen) are mixed, and then, the mixture is heated in an inert gas atmosphere, so that an organometallic complex of the present invention and which has the structure represented by General Formula (G1) can be prepared. This heating process may be performed without the use of a solvent, or with the use of an alcohol-based solvent (e.g., glycerol, ethylene glycol, 2-metoxyethanol, or 2-ethoxyethanol). In addition, there is no particular limitation on a heating means. An oil bath, a sand bath, or an aluminum block bath may be used as a heating means. Alternatively, microwaves can be used as a heating means. In the scheme (b), M denotes a Group 9 element or a Group 10 element. When M is a Group 9 element, n is 3, and when M is a Group 10 element, n is 2. Note that a metal compound of a Group 9 element or a Group 10 element containing a halogen means rhodium chloride hydrate, palladium chloride, iridium chloride hydrate, ammonium hexachloroiridate, potassium tetrachloroplatinate, or the like. Note also that an organic complex compound of a Group 9 element or a Group 10 element containing a halogen means an acetylacetonate complex, a diethylsulfide complex, or the like.

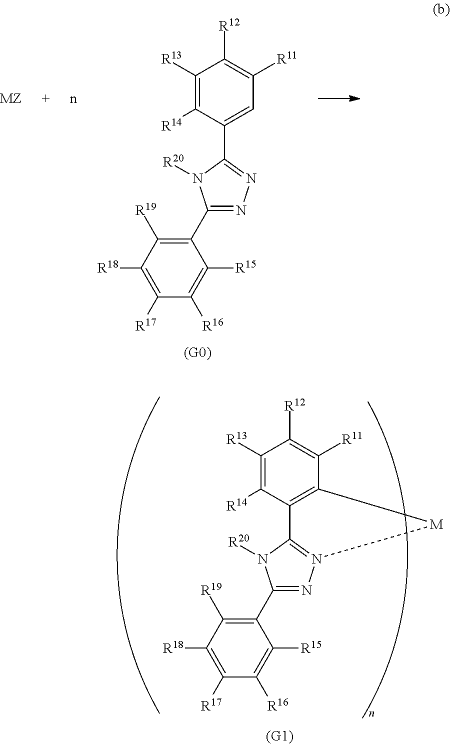

The organometallic complex which is one embodiment of the present invention described above exhibits phosphorescence. Therefore, a light-emitting element having high internal quantum efficiency and high light-emitting efficiency can be manufactured by using the organometallic complex which is one embodiment of the present invention as a light-emitting substance.

In addition, a high-efficiency light-emitting element capable of emitting light having a wavelength band of green to blue can be manufactured, and a phosphorescent material emitting light having the wide wavelength band of green to blue can be prepared.

Note that the organometallic complex which is one embodiment of the present invention can be used in combination with a fluorescent material and can also be used for usage of increasing emission efficiency of the fluorescent material. In other words, in the light-emitting element, the organometallic complex can also be used as a sensitizer for the fluorescent material.

In addition, an organometallic complex generally has poor heat resistance. However, an organometallic complex which is one embodiment of the present invention exhibits phosphorescence and has high heat resistance.

### Embodiment 2

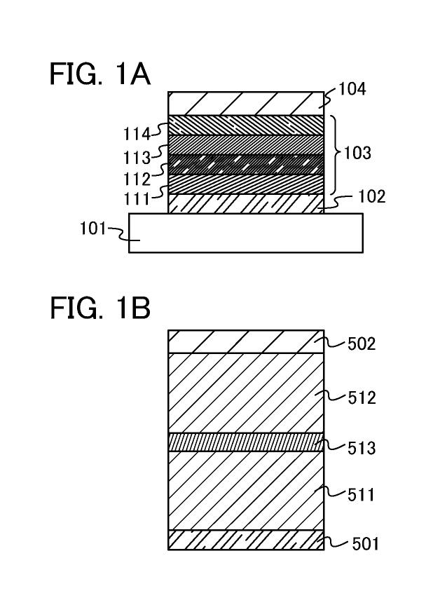

One embodiment of a light-emitting element including the organometallic complex described in Embodiment 1 is described with reference to FIG. 1A.

The light-emitting element includes a pair of electrodes (a first electrode 102 and a second electrode 104) and an EL layer 103 interposed between the pair of electrodes. The light-emitting element described in this embodiment is provided over a substrate 101.

The substrate 101 is used as a support of the light-emitting element. As the substrate 101, a glass substrate, a plastic substrate, or the like can be used. As the substrate 101, a substrate having flexibility (a flexible substrate) or a substrate having a curved surface can also be used. A substrate other than the above substrates can also be used as the substrate 101 as long as it functions as a support of the light-emitting element.

One of the first electrode 102 and the second electrode 104 serves as an anode and the other serves as a cathode. In this embodiment, the first electrode 102 is used as the anode and the second electrode 104 is used as the cathode; however, the present invention is not limited to this structure.

It is preferable to use a metal, an alloy, or a conductive compound, a mixture thereof, or the like having a high work function (specifically, more than or equal to 4.0 eV) as a material for the anode. Specifically, indium oxide-tin oxide (ITO: indium tin oxide), indium oxide-tin oxide containing silicon or silicon oxide, indium oxide-zinc oxide (IZO: indium zinc oxide), indium oxide containing tungsten oxide and zinc oxide (IWZO), and the like can be given. Further, gold (Au), platinum (Pt), nickel (Ni), tungsten (W), chromium (Cr), molybdenum (Mo), iron (Fe), cobalt (Co), copper (Cu), palladium (Pd), nitrides of metal materials (e.g., titanium nitride), and the like can be given.

It is preferable to use a metal, an alloy, or a conductive compound, a mixture thereof, or the like having a low work function (specifically, less than or equal to 3.8 eV) as a material for the cathode. Specifically, an element belonging to Group 1 or Group 2 of the periodic table, that is, an alkali metal such as lithium (Li) and cesium (Cs), an alkaline earth metal such as magnesium (Mg), calcium (Ca), and strontium (Sr), and the like can be given. An alloy containing an alkali metal or an alkaline earth metal (e.g., MgAg or AlLi) can also be used. Moreover, a rare earth metal such as europium (Eu) or ytterbium (Yb), or an alloy containing a rare earth metal can also be used. In the case where an electron-injection layer in contact with the second electrode 104 is provided as part of the EL layer 103, the second electrode 104 can be formed using a variety of conductive materials such as Al, Ag, or ITO, regardless of their work functions. Films of such conductive materials can be formed by a sputtering method, an inkjet method, a spin coating method, or the like.

Although the EL layer 103 can be formed to have a single-layer structure, it is normally formed to have a stacked-layer structure. There is no particular limitation on the stacked-layer structure of the EL layer 103. It is possible to combine, as appropriate, a layer containing a substance having a high electron-transport property (an electron-transport layer) or a layer containing a substance having a high hole-transport property (a hole-transport layer), a layer containing a substance having a high electron-injection property (an electron-injection layer), a layer containing a substance having a high hole-injection property (a hole-injection layer), a layer containing a bipolar substance (a substance having high electron- and hole-transport properties), a layer containing a light-emitting substance (a light-emitting layer), and the like. For example, the EL layer 103 can be formed by an appropriate combination of a hole-injection layer, a hole-transport layer, a light-emitting layer, an electron-transport layer, an electron-injection layer, and the like. FIG. 1A illustrates as the EL layer 103 formed over the first electrode 102, a structure in which a hole-injection layer 111, a hole-transport layer 112, a light-emitting layer 113, and an electron-transport layer 114 are sequentially stacked.

A light-emitting element emits light when current flows due to a potential difference generated between the first electrode 102 and the second electrode 104, and holes and electrons are recombined in the light-emitting layer 113 containing a substance having a high light-emitting property. That is, a light-emitting region is formed in the light-emitting layer 113.

Emitted light is extracted out through one or both of the first electrode 102 and the second electrode 104. Therefore, one or both of the first electrode 102 and the second electrode 104 are light-transmissive electrodes. When only the first electrode 102 has a light-transmitting property, emitted light is extracted from the substrate side through the first electrode 102. Meanwhile, when only the second electrode 104 has a light-transmitting property, emitted light is extracted from the side opposite to the substrate side through the second electrode 104. Further, when the first electrode 102 and the second electrode 104 both have light-transmitting properties, emitted light is extracted to both sides, i.e., the substrate side and the opposite side, through the first electrode 102 and the second electrode 104.

An organometallic complex represented by General Formula (G1) which is one embodiment of the present invention can be used for the light-emitting layer 113, for example. In this case, the light-emitting layer 113 may be formed with a thin film containing the organometallic complex represented by General Formula (G1), or may be formed with a thin film in which a host material is doped with the organometallic complex represented by General Formula (G1).

In order to prevent energy transfer from an exciton which is generated in the light-emitting layer 113, the hole-transport layer 112 or the electron-transport layer 114 which is in contact with the light-emitting layer 113, particularly a carrier- (electron- or hole-) transport layer in contact with a side closer to a light-emitting region in the light-emitting layer 113, is preferably formed using a substance having an energy gap larger than an energy gap of a light-emitting substance contained in the light-emitting layer or an energy gap of an emission center substance contained in the light-emitting layer.

The hole-injection layer 111 contains a substance having a high hole-injection property, and has a function of helping injection of holes from the first electrode 102 to the hole-transport layer 112. By providing the hole-injection layer 111, a difference between the ionization potential of the first electrode 102 and the ionization potential of the hole-transport layer 112 is reduced, so that holes are easily injected. The hole-injection layer 111 is preferably formed using a substance having smaller ionization potential than a substance contained in the hole-transport layer 112 and having larger ionization potential than a substance contained in the first electrode 102, or a substance in which an energy band is bent when the substance is provided as a thin film with a thickness of 1 to 2 nm between the hole-transport layer 112 and the first electrode 102. That is, a substance for the hole-injection layer 111 is preferably selected so that the ionization potential of the hole-injection layer 111 is relatively smaller than that of the hole-transport layer 112. Specific examples of substances having a high hole-injection property include phthalocyanine (abbreviation: H₂Pc), a phthalocyanine-based compound such as copper phthalocyanine (abbreviation: CuPc), a high molecular compound such as poly(ethylenedioxythiophene)/poly(styrenesulfonate) aqueous solution (PEDOT/PSS), and the like.

The hole-transport layer 112 contains a substance with a high hole-transport property. Note that a substance having a high hole-transport property is a substance where hole mobility is higher than electron mobility and the ratio value of hole mobility to electron mobility (=hole mobility/electron mobility) is preferably more than 100. A substance having a hole mobility of more than or equal to 1×10⁻⁶ cm²/Vs is preferably used as a substance having a high hole-transport property. As a specific example for a substance having a high hole-transport property, 4,4′-bis[N-(1-naphthyl)-N-phenylamino]biphenyl (abbreviation: NPB); 4,4′-bis[N-(3-methylphenyl]-N-phenylamino]biphenyl (abbreviation: TPD); 4,4′,4″-tris(N,N-diphenylamino)triphenylamine (abbreviation: TDATA); 4,4′,4″-tris[N-(3-methylphenyl)-N-phenylamino]triphenylamine (abbreviation: MTDATA); N,N′-bis[4-[bis(3-methylphenyl)amino]phenyl]-N,N′-diphenyl-[1,1′-biphenyl]-4,4′-diamine (abbreviation: DNTPD); 1,3,5-tris[N,N-di(m-tolyl)amino]benzene (abbreviation: m-MTDAB); 4,4′,4″-tris(N-carbazolyl)triphenylamine (abbreviation: TCTA); phthalocyanine (abbreviation: H₂Pc); copper phthalocyanine (abbreviation: CuPc); vanadyl phthalocyanine (abbreviation: VOPc) and the like can be given. Note that the hole-transport layer 112 may have a single-layer structure or a stacked-layer structure.

The electron-transport layer 114 contains a substance with a high electron-transport property. Note that a substance having a high electron-transport property is a substance where electron mobility is higher than hole mobility and the ratio value of electron mobility to hole mobility (=electron mobility/hole mobility) is preferably more than 100. A substance having an electron mobility of more than or equal to 1×10⁻⁶ cm²/Vs is preferably used as a substance having a high electron-transport property. Specific examples of the substances having a high electron-transport property include a metal complex having a quinoline skeleton, a metal complex having a benzoquinoline skeleton, a metal complex having an oxazole-based ligand, and a metal complex having a thiazole-based ligand. Specific examples of metal complexes having a quinoline skeleton include tris(8-quinolinolato)aluminum (abbreviation: Alq), tris(4-methyl-8-quinolinolato)aluminum (abbreviation: Almq₃), and bis(2-methyl-8-quinolinolato)(4-phenylphenolato)aluminum (abbreviation: BAlq). A specific example of a metal complex having a benzoquinoline skeleton is bis(10-hydroxybenzo[h]quinolinato)beryllium (abbreviation: BeBq₂). A specific example of a metal complex having an oxazole-based ligand is bis[2-(2-hydroxyphenyl)benzoxazolato]zinc (abbreviation: Zn(BOX)₂). A specific example of a metal complex having a thiazole-based ligand is bis[2-(2-hydroxyphenyl)benzothiazolato]zinc (abbreviation: Zn(BTZ)₂). In addition to the metal complexes, 2-(4-biphenylyl)-5-(4-tert-butylphenyl)-1,3,4-oxadiazole (abbreviation: PBD), 1,3-bis[5-(p-tert-butylphenyl)-1,3,4-oxadiazole-2-yl]benzene (abbreviation: OXD-7), 3-(4-biphenylyl)-4-phenyl-5-(4-tert-butylphenyl)-1,2,4-triazole (abbreviation: TAZ 01), bathophenanthroline (abbreviation: BPhen), bathocuproine (BCP), or the like can be used. The substances specifically listed above are mainly substances having an electron mobility of more than or equal to 10⁻⁶ cm²/Vs. Note that any substance other than the above substances may be used for the electron-transport layer 114 as long as the electron-transport property is higher than the hole-transport property. Further, the electron-transport layer 114 may have a single-layer structure or a stacked-layer structure.

Further, a layer for controlling transport of electron carriers may be provided between the light-emitting layer 113 and the electron-transport layer 114. Note that the layer for controlling transport of electron carriers is a layer obtained by adding a small amount of substance having a high electron-trapping property to the above-described material having a high electron-transport property. By providing the layer for controlling transport of electron carriers, it is possible to prevent transfer of electron carriers, and to adjust carrier balance. Such a structure is very effective in preventing a problem (such as shortening of element lifetime) caused when electrons pass through the light-emitting layer.

In addition, an electron-injection layer may be provided between the electron-transport layer 114 and the second electrode 104, in contact with the second electrode 104. As the electron-injection layer, a layer which contains a substance having an electron-transport property and an alkali metal, an alkaline earth metal, or a compound thereof such as lithium fluoride (LiF), cesium fluoride (CsF), or calcium fluoride (CaF₂) may be used. Specifically, a layer containing Alq and magnesium (Mg) can be used. By providing the electron-injection layer, electrons can be injected efficiently from the second electrode 104.

Various methods can be used for forming the EL layer 103, regardless of a dry method or a wet method. For example, a vacuum evaporation method, an inkjet method, a spin-coating method, or the like can be used. When the EL layer 103 has a stacked-layer structure, deposition methods of the layers may be different or the same.

The first electrode 102 and the second electrode 104 may be formed by a wet method using a sol-gel method, or a wet method using a paste of a metal material. Further, the electrodes may be formed by a dry method such as sputtering or vacuum evaporation.

### Embodiment 3

In this embodiment, an embodiment of a light-emitting element in which a plurality of light-emitting units are stacked (hereinafter this light-emitting element is referred to as a “tandem light-emitting element”) is described with reference to FIG. 1B. The tandem light-emitting element is a light-emitting element having a plurality of light-emitting units between a first electrode and a second electrode. The light-emitting units can be similar to the EL layer 103 described in Embodiment 2. That is, the light-emitting element described in Embodiment 2 has a single light-emitting unit, and the light-emitting element described in this embodiment has a plurality of light-emitting units.

In FIG. 1B, a first light-emitting unit 511 and a second light-emitting unit 512 are stacked between a first electrode 501 and a second electrode 502. Electrodes similar to those described in Embodiment 2 can be used as the first electrode 501 and the second electrode 502. Alternatively, the structures of the first light-emitting unit 511 and the second light-emitting unit 512 may be the same or different from each other, and each of the structures can be similar to the structure described in Embodiment 2.

A charge-generating layer 513 is provided between the first light-emitting unit 511 and the second light-emitting unit 512. The charge-generating layer 513 contains a composite material of an organic compound and a metal oxide and has a function of injecting electrons to one side of the light-emitting unit, and holes to the other side of the light-emitting unit, when voltage is applied between the first electrode 501 and the second electrode 502. The composite material of the organic compound and the metal oxide can achieve low-voltage driving and low-current driving because of the superior carrier-injecting property and carrier-transporting property.

It is preferable to use an organic compound which has a hole-transport property and has a hole mobility of more than or equal to 10⁻⁶ cm²/Vs as the organic compound. Specific examples of the organic compound include an aromatic amine compound, a carbazole compound, aromatic hydrocarbon, and a high molecular compound (an oligomer, a dendrimer, a polymer, or the like). It is possible to use oxide of a metal belonging to Group 4 to Group 8 in the periodic table as the metal oxide; specifically, it is preferable to use any of vanadium oxide, niobium oxide, tantalum oxide, chromium oxide, molybdenum oxide, tungsten oxide, manganese oxide, and rhenium oxide because their electron-accepting property is high. In particular, molybdenum oxide is especially preferable because it is stable in the air, its hygroscopic property is low, and it can be easily handled.

The charge-generating layer 513 may have a single-layer structure or a stacked-layer structure. For example, it is possible to have a stacked-layer structure of a layer containing a composite material of an organic compound and a metal oxide, and a layer containing one compound selected from electron-donating substances and a compound having a high electron-transport property; or a stacked-layer structure of a layer containing a composite material of an organic compound and a metal oxide, and a transparent conductive film.

In this embodiment, the light-emitting element having two light-emitting units is described; however, the present invention is not limited to this structure. That is, a tandem light-emitting element may be a light-emitting element having three or more light-emitting units. Note that the light-emitting elements having three or more light-emitting units include a charge-generating layer between the light-emitting units. For example, it is possible to form a light-emitting element having a first unit formed using an organometallic complex which is one embodiment of the present invention, and a second unit formed using a light-emitting material which emits light with a longer wavelength than the organometallic complex (e.g., red light). In addition, it is also possible to form a light-emitting element having a first unit formed using an organometallic complex which is one embodiment of the present invention, a second unit formed using a first light-emitting material which emits light with a longer wavelength than the organometallic complex (e.g., red light), and a third unit formed using a second light-emitting material which emits light with a longer wavelength than the organometallic complex and a shorter wavelength than the first light-emitting material (e.g., green light). By using these light-emitting elements, a white light-emitting device can be realized. In particular, an emission spectrum of the organometallic complex which is one embodiment of the present invention has a feature of a broad peak. Thus, by using the organometallic complex which is one embodiment of the present invention in at least one light-emitting unit in a tandem light-emitting element, a light-emitting device with excellent white reproducibility (color rendering properties) can be easily provided.

By arranging a plurality of light-emitting units that are partitioned by a charge-generating layer between a pair of electrodes, the tandem light-emitting element of this embodiment can be an element having a long lifetime and emitting light in a high luminance region while keeping a current density low.

### Embodiment 4

In this embodiment, described are a passive-matrix light-emitting device and an active-matrix light-emitting device which are examples of a light-emitting device manufactured with the use of the light-emitting element described in the above embodiments.

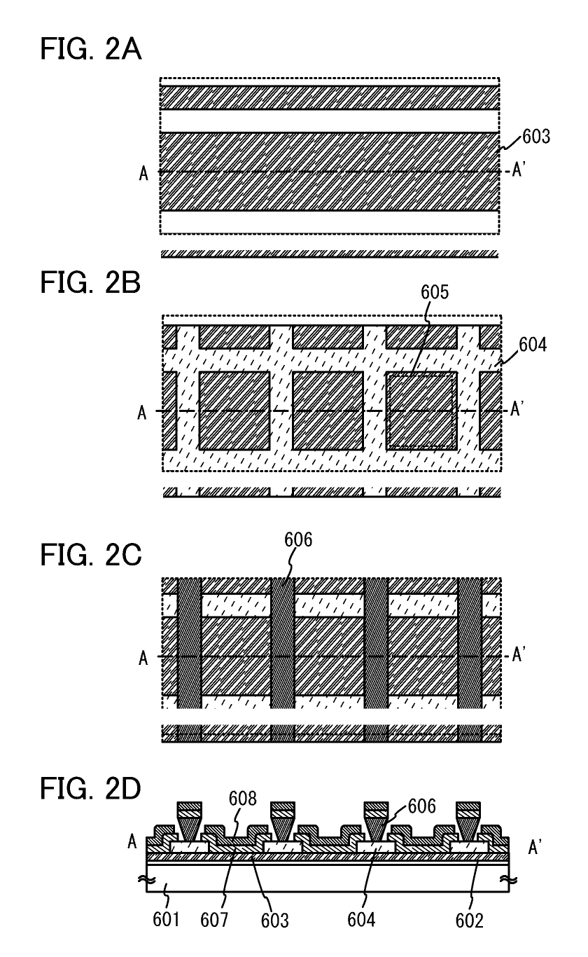

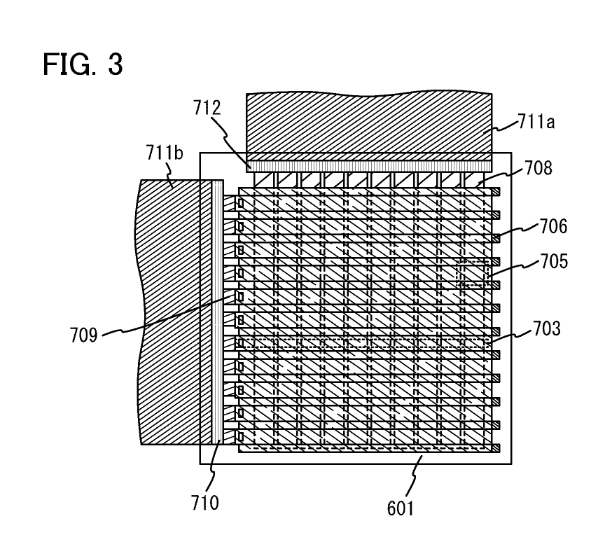

FIGS. 2A to 2D and FIG. 3 illustrate an example of the passive-matrix light-emitting device.

In a passive-matrix (also called simple-matrix) light-emitting device, a plurality of anodes arranged in stripes (in stripe form) are provided to be perpendicular to a plurality of cathodes arranged in stripes. A light-emitting layer is interposed at each intersection. Therefore, a pixel at an intersection of an anode selected (to which voltage is applied) and a cathode selected emits light.

FIGS. 2A to 2C are top views of a pixel portion before sealing. FIG. 2D is a cross-sectional view taken along chain line A-A′ in FIGS. 2A to 2C.

Over a substrate 601, an insulating layer 602 is formed as a base insulating layer. Note that the insulating layer 602 is not necessarily formed if the base insulating layer is not needed. Over the insulating layer 602, a plurality of first electrodes 603 are arranged in stripes at regular intervals (FIG. 2A). Note that each of the first electrodes 603 in this embodiment corresponds to the first electrode 102 in Embodiment 2.

In addition, a partition 604 having openings 605 corresponding to pixels is provided over the first electrodes 603. The partition 604 is formed using an insulating material. For example, a photosensitive or non-photosensitive organic material such as polyimide, acrylic, polyamide, polyimide amide, a resist, benzocyclobutene, or an SOG film such as an SiOₓ film that contains an alkyl group can be used as the insulating material. Note that the openings 605 corresponding to pixels serve as light-emitting regions (FIG. 2B).

Over the partition 604 having openings, a plurality of partitions 606 are provided to intersect with the first electrodes 603 (FIG. 2C). The plurality of partitions 606 are formed in parallel to each other, and are inversely tapered.

Over each of the first electrodes 603 and the partition 604, an EL layer 607 and a second electrode 608 are sequentially stacked (FIG. 2D). Note that the EL layer 607 in this embodiment corresponds to the EL layer 103 in Embodiment 2, and the second electrode 608 in this embodiment corresponds to the second electrode 104 in Embodiment 2. The total height of the partition 604 and the partition 606 is larger than the total thickness of the EL layer 607 and the second electrode 608; therefore, the EL layer 607 and the second electrode 608 are divided into a plurality of regions as illustrated in FIG. 2D. Note that the plurality of divided regions are electrically isolated from one another.

The second electrodes 608 are formed in stripes and extend in the direction in which they intersect with the first electrodes 603. Note that a part of the EL layers 607 and a part of conductive layers forming the second electrodes 608 are formed over the inversely tapered partitions 606; however, they are separated from the EL layers 607 and the second electrodes 608.

In addition, if necessary, a sealing material such as a sealing can or a glass substrate may be attached to the substrate 601 by an adhesive agent for sealing so that the light-emitting element can be disposed in the sealed space. Thus, deterioration of the light-emitting element can be prevented. The sealed space may be filled with filler or a dry inert gas. Further, a desiccant or the like is preferably put between the substrate and the sealing material to prevent deterioration of the light-emitting element due to moisture or the like. The desiccant removes a minute amount of moisture, thereby achieving sufficient desiccation. As the desiccant, oxide of an alkaline earth metal such as calcium oxide or barium oxide, zeolite, or silica gel can be used. Oxide of an alkaline earth metal absorbs moisture by chemical adsorption, and zeolite and silica gel adsorb moisture by physical adsorption.

FIG. 3 is a top view of the passive-matrix light-emitting device illustrated in FIGS. 2A to 2D that is provided with a flexible printed circuit (an FPC) or the like.

As illustrated in FIG. 3, in a pixel portion forming an image display, scanning lines and data lines are arranged to intersect with each other so that the scanning lines and the data lines are perpendicular to each other.

The first electrodes 603 in FIGS. 2A to 2D correspond to scan lines 703 in FIG. 3; the second electrodes 608 in FIG. 2D correspond to data lines 708 in FIG. 3; and the inversely-tapered partitions 606 correspond to partitions 706. The EL layers 607 illustrated in FIG. 2D are interposed between the data lines 708 and the scanning lines 703, and an intersection indicated by a region 705 corresponds to one pixel.

Note that the scanning lines 703 are electrically connected at their ends to connection wirings 709, and the connection wirings 709 are connected to an FPC 711b via an input terminal 710. In addition, the data lines 708 are connected to an FPC 711a via an input terminal 712.

An optical film such as a polarizing plate, a circularly polarizing plate (including an elliptically polarizing plate), a retardation plate (a quarter-wave plate or a half-wave plate), or a color filter may be provided as needed. Further, an anti-reflection film may be provided in addition to the polarizing plate or the circularly polarizing plate. By providing the anti-reflection film, anti-glare treatment can be carried out by which reflected light can be scattered by roughness of a surface so as to reduce reflection.

Although FIG. 3 illustrates the example in which a driver circuit is not provided over the substrate, an IC chip including a driver circuit may be mounted on the substrate.

When the IC chip is mounted, a data line side IC and a scanning line side IC, in each of which the driver circuit for transmitting a signal to a pixel portion is formed, are mounted on the periphery of (outside) the pixel portion. As a method for mounting an IC chip, a COG method, TCP, a wire bonding method, or the like can be used. The TCP is a TAB tape mounted with the IC, and the TAB tape is connected to a wiring over an element formation substrate to mount the IC. The data line side IC and the scanning line side IC may be formed over a silicon substrate, a silicon on insulator (SOI) substrate, a glass substrate, a quartz substrate, or a plastic substrate.

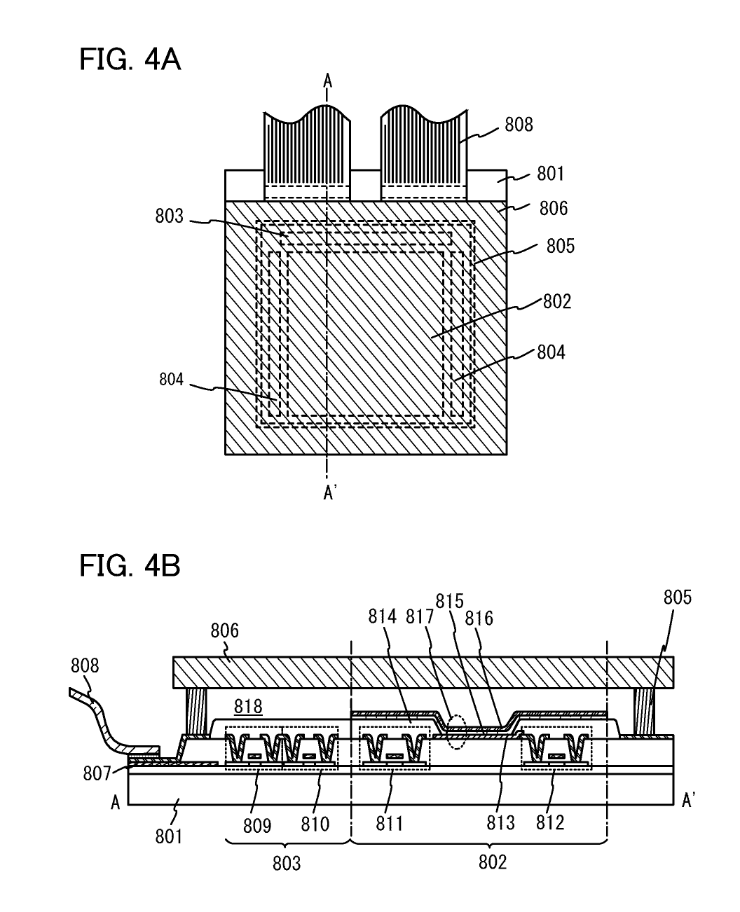

Next, an example of the active-matrix light-emitting device is described with reference to FIGS. 4A and 4B. FIG. 4A is a top view illustrating a light-emitting device and FIG. 4B is a cross-sectional view taken along dashed line A-A′ in FIG. 4A. The active-matrix light-emitting device of this embodiment includes a pixel portion 802 provided over an element substrate 801, a driver circuit portion (a source-side driver circuit) 803, and a driver circuit portion (a gate-side driver circuit) 804. The pixel portion 802, the driver circuit portion 803 and the driver circuit portion 804 are sealed between the element substrate 801 and the sealing substrate 806 by the sealing material 805.

In addition, over the element substrate 801, a lead wiring 807 for connecting an external input terminal, through which a signal (e.g., a video signal, a clock signal, a start signal, a reset signal, or the like) and a potential from the external are transmitted to the driver circuit portion 803 and the driver circuit portion 804, is provided. Here, an example is described in which an FPC 808 is provided as the external input terminal Note that although only an FPC is illustrated here, a printed wiring board (PWB) may be attached thereto. In this specification, the light-emitting device includes in its category the light-emitting device itself and the light-emitting device on which the FPC or the PWB is mounted.

Next, a cross-sectional structure of the active-matrix light-emitting device is described with reference to FIG. 4B. Although the driver circuit portion 803, the driver circuit portion 804, and the pixel portion 802 are formed over the element substrate 801, the pixel portion 802 and the driver circuit portion 803 which is the source side driver circuit are illustrated in FIG. 4B.

In the driver circuit portion 803, an example including a CMOS circuit which is a combination of an n-channel TFT 809 and a p-channel TFT 810 is illustrated. Note that a circuit included in the driver circuit portion can be formed using various types of circuits such as a CMOS circuit, a PMOS circuit, or an NMOS circuit. In this embodiment, a driver-integrated type in which a driver circuit and the pixel portion are formed over the same substrate is described; however, the present invention is not limited to this structure, and a driver circuit (either or both the driver circuit portion 803 or/and the driver circuit portion 804) can be formed over a substrate that is different from the substrate over which a pixel portion is formed.

The pixel portion 802 has a plurality of pixels, each including a switching TFT 811, a current-controlling TFT 812, and an anode 813 electrically connected to a wiring (a source electrode or a drain electrode) of the current-controlling TFT 812. An insulator 814 is formed so as to cover an end portion of the anode 813. Here, the insulator 814 is formed using a positive photosensitive acrylic resin. Note that there is no particular limitation on structures of the TFTs such as the switching TFT 811 and the current-controlling TFT 812. For example, a staggered TFT or an inverted-staggered TFT may be used. In addition, a top-gate TFT or a bottom-gate TFT may be used. There is no particular limitation also on materials of a semiconductor used for the TFTs, and silicon or an oxide semiconductor such as oxide including indium, gallium, and zinc may be used. In addition, crystallinity of a semiconductor used for the TFT is not particularly limited either; an amorphous semiconductor or a crystalline semiconductor may be used.

A light-emitting element 817 includes an anode 813, an EL layer 815, and a cathode 816. Since the structure and materials for the light-emitting element is described in Embodiment 2, a detailed description is omitted in this embodiment. Note that the anode 813, the EL layer 815, and the cathode 816 in FIGS. 4A and 4B correspond to the first electrode 102, the EL layer 103, and the second electrode 104 in Embodiment 2, respectively. Although not illustrated, the cathode 816 is electrically connected to the FPC 808 which is an external input terminal.

The insulator 814 is provided at an end portion of the anode 813. In addition, in order that the cathode 816 that is formed over the insulator 814 at least favorably covers the insulator 814, the insulator 814 is preferably formed so as to have a curved surface with curvature at an upper end portion or a lower end portion. For example, it is preferable that the upper end portion or the lower end portion of the insulator 814 have a curved surface with a radius of curvature (0.2 μm to 3 μm). The insulator 814 can be formed using an organic compound such as a negative photosensitive resin which becomes insoluble in an etchant by light or a positive photosensitive resin which becomes soluble in an etchant by light, or an inorganic compound such as silicon oxide or silicon oxynitride can be used.

Although the cross-sectional view of FIG. 4B illustrates only one light-emitting element 817, a plurality of light-emitting elements are arranged in matrix in the pixel portion 802. For example, light-emitting elements that emit light of three kinds of colors (R, G, and B) are formed in the pixel portion 802, so that a light-emitting device capable of full color display can be obtained. Alternatively, a light-emitting device capable of full color display may be manufactured by a combination with color filters.

The light-emitting element 817 is formed in a space 818 that is surrounded by the element substrate 801, the sealing substrate 806, and the sealing material 805. The space 818 may be filled with a rare gas, a nitrogen gas, or the sealing material 805.

It is preferable to use as the sealing material 805, a material that transmits as little moisture and oxygen as possible, such as an epoxy-based resin. As the sealing substrate 806, a glass substrate, a quartz substrate, a plastic substrate formed of FRP (fiberglass-reinforced plastics), PVF (polyvinyl fluoride), polyester, acrylic, or the like can be used.

As described above, an active-matrix light-emitting device can be obtained.

In addition, when the light-emitting element is used for an active-matrix light-emitting device, the color rendering property of light emission of the light-emitting element becomes a concern. In contrast, when the organometallic complex of the present invention and which has a broad emission spectrum is used, light of the entire visible light region is emitted; thus, the color rendering property becomes high and the light emission can be close to natural light accordingly.

This embodiment can be combined with any of the other embodiments and examples.

### Embodiment 5

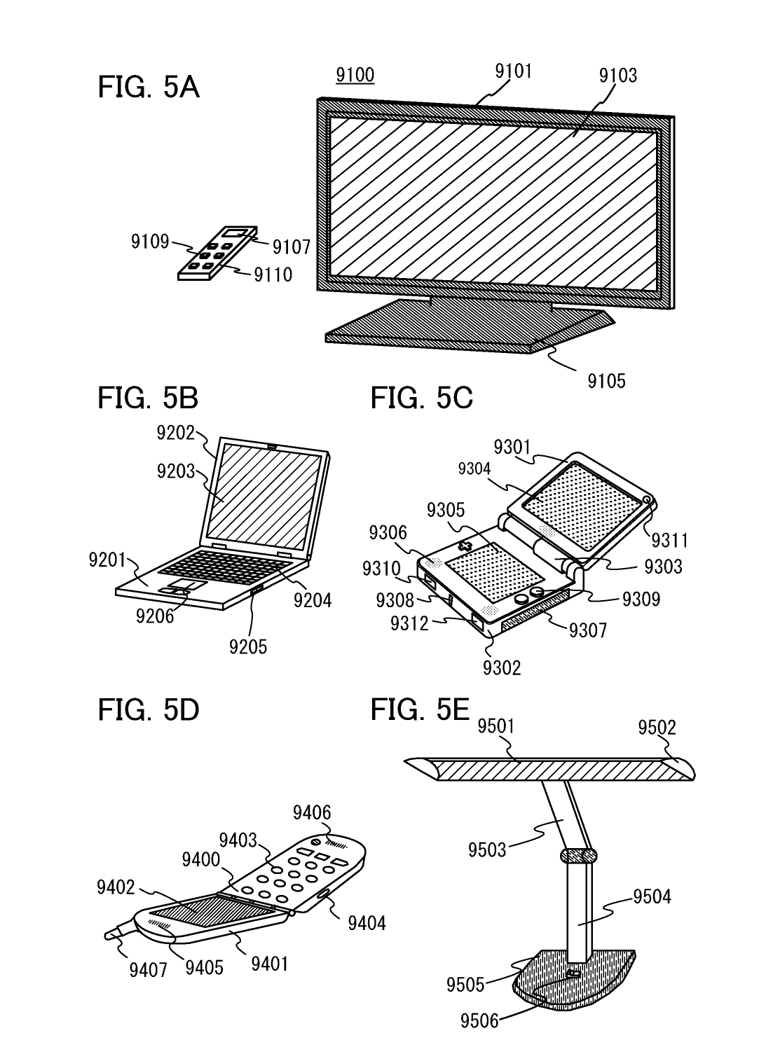

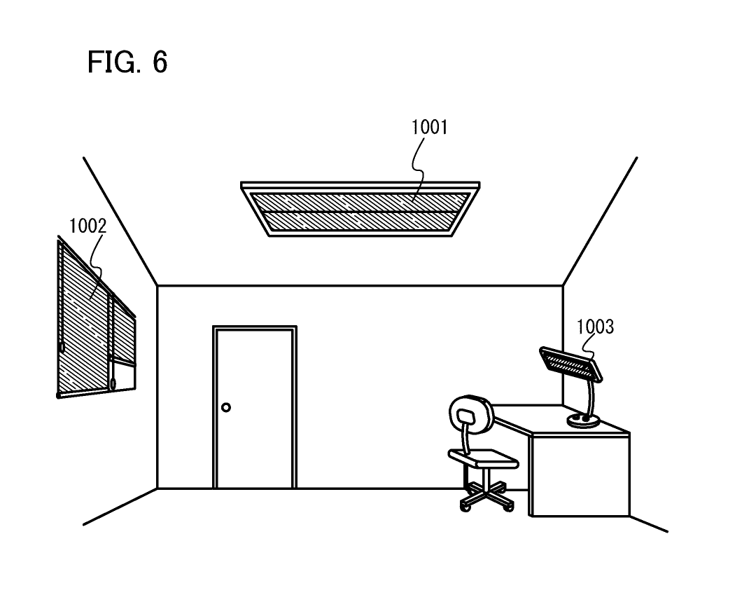

In this embodiment, specific examples of electronic devices and lighting devices each of which is manufactured using a light-emitting device described in any of the above embodiments are described with reference to FIGS. 5A to 5E and FIG. 6.

Examples of electronic devices that can be applied to the present invention include a television set (also referred to as a television or a television receiver), a monitor of a computer, a camera such as a digital camera or a digital video camera, a digital photo frame, a mobile phone, a portable game machine, a portable information terminal, an audio reproducing device, an amusement machine (e.g., a pachinko machine or a slot machine), a game machine, and the like. Some specific examples of these electronic devices and lighting devices are illustrated in FIGS. 5A to 5E and FIG. 6.

FIG. 5A illustrates a television set 9100. In the television set 9100, a display portion 9103 is incorporated in a housing 9101. A light-emitting device manufactured using one embodiment of the present invention can be used in the display portion 9103, so that an image can be displayed on the display portion 9103. Note that the housing 9101 is supported by a stand 9105 here.

The television set 9100 can be operated with an operation switch of the housing 9101 or a separate remote controller 9110. Channels and volume can be controlled with an operation key 9109 of the remote controller 9110 so that an image displayed on the display portion 9103 can be controlled. Furthermore, the remote controller 9110 may be provided with a display portion 9107 for displaying data output from the remote controller 9110.

The television set 9100 illustrated in FIG. 5A is provided with a receiver, a modem, and the like. With the use of the receiver, the television set 9100 can receive general TV broadcasts. Moreover, when the television set 9100 is connected to a communication network with or without wires via the modem, one-way (from a sender to a receiver) or two-way (between a sender and a receiver or between receivers) information communication can be performed.

Since a light-emitting device manufactured using one embodiment of the present invention has high emission efficiency and a long lifetime, the television set including the light-emitting device in the display portion 9103 can display an image with improved image quality as compared with conventional images.

FIG. 5B illustrates a computer which includes a main body 9201, a housing 9202, a display portion 9203, a keyboard 9204, an external connection port 9205, a pointing device 9206, and the like. The computer is manufactured using a light-emitting device manufactured using one embodiment of the present invention for the display portion 9203.

Since a light-emitting device manufactured using one embodiment of the present invention has high emission efficiency and a long lifetime, the computer including the light-emitting device in the display portion 9203 can display an image with improved image quality as compared with conventional images.

FIG. 5C illustrates a portable game machine including two housings, a housing 9301 and a housing 9302 which are jointed with a connector 9303 so as to be opened and closed. A display portion 9304 is incorporated in the housing 9301, and a display portion 9305 is incorporated in the housing 9302. In addition, the portable game machine illustrated in FIG. 5C includes an input means such as operation keys 9309, a connection terminal 9310, a sensor 9311 (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), or a microphone 9312. The portable game machine may further be provided with a speaker portion 9306, a recording medium insertion portion 9307, an LED lamp 9308, and the like. Needless to say, the structure of the portable game machine is not limited to the above, and it is acceptable as long as the light-emitting device manufactured using any of the above embodiments is used for one or both of the display portion 9304 and the display portion 9305.

The portable game machine illustrated in FIG. 5C has a function of reading a program or data stored in a recording medium to display it on the display portion, and a function of sharing data with another portable game machine by wireless communication. Note that a function of the portable game machine illustrated in FIG. 5C is not limited to the above, and the portable game machine can have a variety of functions.

Since a light-emitting device manufactured using one embodiment of the present invention has high emission efficiency and a long lifetime, the portable game machine including the light-emitting device in the display portions (9304 and 9305) can display an image with improved image quality as compared with conventional images.

FIG. 5D illustrates an example of a mobile phone. A mobile phone 9400 is provided with a display portion 9402 incorporated in a housing 9401, operation buttons 9403, an external connection port 9404, a speaker 9405, a microphone 9406, an antenna 9407, and the like. Note that the mobile phone 9400 is manufactured using a light-emitting device manufactured using one embodiment of the present invention for the display portion 9402.

Users can input data, make a call, or text a message by touching the display portion 9402 of the mobile phone 9400 illustrated in FIG. 5D with their fingers or the like.

There are mainly three screen modes for the display portion 9402. The first mode is a display mode mainly for displaying images. The second mode is an input mode mainly for inputting data such as text. The third mode is a display-and-input mode in which two modes of the display mode and the input mode are combined.

For example, in the case of making a call or text messaging, an input mode mainly for inputting text is selected for the display portion 9402 so that characters displayed on a screen can be input. In this case, it is preferable to display a keyboard or number buttons on almost the entire area of the screen of the display portion 9402.

By providing a detection device which includes a sensor for detecting inclination, such as a gyroscope or an acceleration sensor, inside the mobile phone 9400, the direction of the mobile phone 9400 (whether the mobile phone 9400 is placed horizontally or vertically for a landscape mode or a portrait mode) is determined so that display on the screen of the display portion 9402 can be automatically switched.

Further, the screen modes are switched by touching the display portion 9402 or operating the operation button 9403 provided on the housing 9401. Alternatively, the screen modes can be switched depending on kinds of images displayed in the display portion 9402. For example, when a signal of an image displayed on the display portion is a signal of moving image data, the screen mode is switched to the display mode. When the signal is a signal of text data, the screen mode is switched to the input mode.

Furthermore, in the input mode, when input by touching the display portion 9402 is not performed for a certain period while a signal is detected by the optical sensor in the display portion 9402, the screen mode may be controlled so as to be switched from the input mode to the display mode.

The display portion 9402 can also function as an image sensor. For example, an image of a palm print, a fingerprint, or the like is taken by touching the display portion 9402 with the palm or the finger, whereby personal authentication can be performed. Further, by providing a backlight or a sensing light source which emits a near-infrared light in the display portion, an image of a finger vein, a palm vein, or the like can be taken.

Since a light-emitting device manufactured using one embodiment of the present invention has high emission efficiency and a long lifetime, the mobile phone including the light-emitting device in the display portion 9402 can display an image with improved image quality as compared with conventional images.

FIG. 5E illustrates a tabletop lighting device including a lighting portion 9501, a shade 9502, an adjustable arm 9503, a support 9504, a base 9505, and a power supply switch 9506. The tabletop lighting device is manufactured using a light-emitting device manufactured using one embodiment of the present invention for the lighting portion 9501. Note that the modes of the lighting device is not limited to tabletop lighting devices, but include ceiling-fixed lighting devices, wall-hanging lighting devices, portable lighting devices, and the like.

FIG. 6 illustrates an example in which the light-emitting device manufactured using one embodiment of the present invention is used for an indoor lighting device 1001. Since the light-emitting device manufactured using one embodiment of the present invention can have a large area, the light-emitting device can be used as a lighting apparatus having a large area. In addition, the light-emitting device described in the above embodiments can be made thin and thus can be used as a roll-up type lighting device 1002. As illustrated in FIG. 6, a tabletop lighting device 1003 which is similar to the lighting device illustrated in FIG. 5E may be used in a room provided with the indoor lighting device 1001.

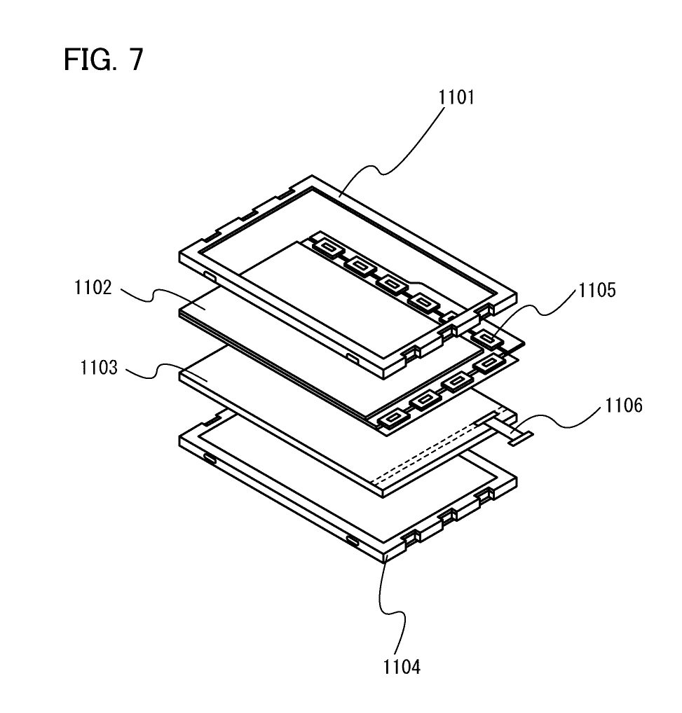

The light-emitting device of one embodiment of the present invention can also be used as a lighting device. FIG. 7 shows an example of a liquid crystal display device in which the light-emitting device which is one embodiment of the present invention is used as a backlight. The liquid crystal display device illustrated in FIG. 7 includes a housing 1101, a liquid crystal layer 1102, a backlight 1103, and a housing 1104. The liquid crystal layer 1102 is electrically connected to a driver IC 1105. The light-emitting device which is one embodiment of the present invention is used as the backlight 1103, and current is supplied to the backlight 1103 through a terminal 1106.

By using the light-emitting device of one embodiment of the present invention as a backlight of a liquid crystal display device as described above, a backlight having low power consumption can be obtained. Moreover, since the light-emitting device which is one embodiment of the present invention is a lighting device for surface light emission and the enlargement of the light-emitting device is possible, the backlight can be made larger. Accordingly, a larger-area liquid crystal display device having low power consumption can be obtained.

When the light-emitting device which is one embodiment of the present invention is used for an electronic device, the color rendering property of light emission of the light-emitting element becomes a concern. In particular, for an electronic device such as a display device or a lighting device, the color rendering property is a major concern. This is because when a plurality of light-emitting materials each of which has a sharp emission spectrum are used in a white light-emitting element, the color rendering property becomes low. In contrast, when the organometallic complex which is one embodiment of the present invention and which has a broad emission spectrum is used, light of the entire visible light region is emitted; thus, the color rendering property becomes high and the light emission can be close to natural light accordingly. In particular, the light-emitting device which is one embodiment of the present invention is suitable for a display device, a lighting device, or the like.

In the above-described manner, electronic devices and lighting devices can be provided using a light-emitting device manufactured using one embodiment of the present invention. The scope of application of the light-emitting device manufactured using one embodiment of the present invention is so wide that it can be applied to a variety of fields of electronic devices.

This embodiment can be combined with any of the other embodiments and examples.

### EXAMPLE 1

### SYNTHESIS EXAMPLE 1

In Synthesis Example 1, a synthesis example of an organometallic complex tris[3,5-bis(4-fluorophenyl)-4-phenyl-4H-1,2,4-triazolato]iridium(III) (abbreviation: [Ir(Ftaz)₃]) which is one embodiment of the present invention represented by Structural Formula (100) in Embodiment 1 is specifically described.

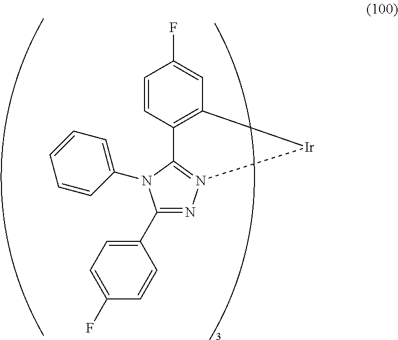

### Step 1: Synthesis of 4-fluorobenzoylhydrazine

First, 25 g of 4-fluoroethyl benzoate and 100 mL of ethanol were put in a 500 mL three-neck flask and stirred. Then, 20 mL of hydrazine monohydrate was added to this mixed solution, and heated and stirred at 80° C. for 6 hours. After the stirring, the reacted mixture was added to 250 mL of water, and a white solid was precipitated. Ethyl acetate was added to this mixture, and the solid was dissolved. An organic layer and an aqueous layer were separated, and the aqueous layer was extracted with ethyl acetate. The resulting extract and organic layer were together washed with a saturated aqueous sodium chloride solution, and then anhydrous magnesium sulfate was added to the organic layer for drying. After the drying, this mixture was subjected to gravity filtration, and the resulting filtrate was concentrated to give a white solid. The given white solid was washed with hexane, so that 4-fluorobenzoylhydrazine was prepared (a white solid, yield: 57%). The synthesis scheme of Step 1 is shown by (a-1).

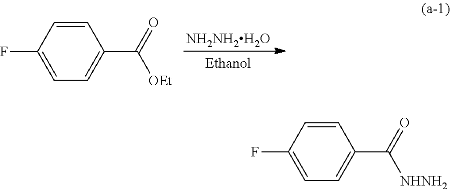

### Step 2: Synthesis of N,N′-bis(4-fluorobenzoyl)hydrazine

Next, 5.0 g of 4-fluorobenzoylhydrazine prepared in Step 1 above and 50 mL of N-methyl-2-pyrrolidone (abbreviation: NMP) were put in a 200 mL three-neck flask and mixed. A mixed solution of 4 mL of 4-fluorobenzoyl chloride and 5 mL of NMP was dripped to this mixed solution through a 50 mL dropping funnel, and stirred at room temperature for 1 hour and a half After the stirring, this mixed solution was added to 250 mL of water, and a white solid was precipitated. The precipitated solid was washed with 1M hydrochloric acid and subjected to suction filtration to give a white solid. The given solid was washed with methanol, so that N,N′-bis(4-fluorobenzoyl)hydrazine was prepared (a white solid, yield: 56%). The synthesis scheme of Step 2 is shown by (b-1).

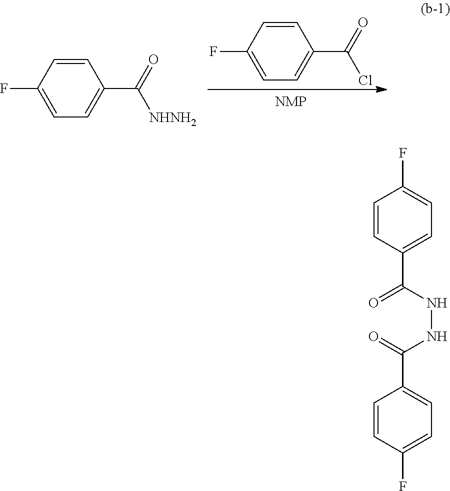

### Step 3: Synthesis of 1,2-bis[(4-fluorophenyl)chloromethylidene]hydrazine

Next, 5.0 g of N,N′-bis(4-fluorobenzoyl)hydrazine that was prepared in Step 2 above and 100 mL of toluene were put in a 500 mL three-neck flask and mixed. Then, 7.5 g of phosphorus pentachloride was added to this mixed solution, and stirred at 110° C. for 6 hours. After the stirring, the reaction solution was added to 200 mL of water and stirred for 1 hour. An organic layer and an aqueous layer were separated, and the separated organic layer was washed with water and then a saturated aqueous solution of sodium hydrogen carbonate. After the washing, anhydrate magnesium sulfate was added to the organic layer for drying. The resulting mixture was subjected to gravity filtration, and the filtrate was concentrated to give a yellow solid. This solid was washed with methanol, so that 1,2-bis[(4-fluorophenyl)chloromethylidene]hydrazine was prepared (a yellow solid, yield: 87%). The synthesis scheme of Step 3 is shown by (c-1).

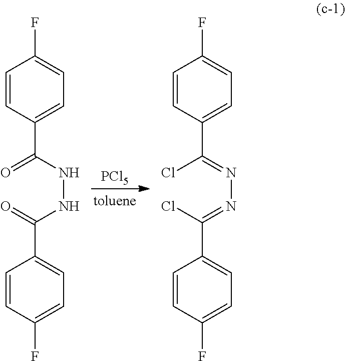

### Step 4: Synthesis of 3,5-bis(4-fluorophenyl)-4-phenyl-4H-1,2,4-triazole (abbreviation: HFtaz)

Next, 4.9 g of 1,2-bis[(4-fluorophenyl)chloromethylidene]hydrazine that was prepared in Step 3 above, 1.5 g of aniline, and 50 mL of N,N-dimethylaniline were put in a 200 mL three-neck flask, and heated and stirred at 120° C. for 5 hours. After the stirring, the reaction solution was added to 1 M hydrochloric acid, and the mixture was stirred for 30 minutes, whereby a solid was precipitated. The precipitated solid was subjected to suction filtration to give a solid. Recrystallization was carried out on the given solid with a mixed solvent of hexane and ethanol, so that 3,5-bis(4-fluorophenyl)-4-phenyl-4H-1,2,4-triazole (abbreviation: HFtaz) was prepared (a white solid, yield: 73%). The synthetic scheme of Step 4 is shown by (d-1).

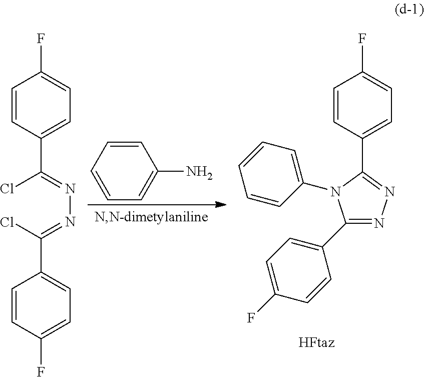

### Step 5: Synthesis of tris[3,5-bis(4-fluorophenyl)-4-phenyl-4H-1,2,4-triazolato]iridium(III) (abbreviation: [Ir(Ftaz)₃])

Next, 1.76 g of the ligand HFtaz that was prepared in Step 4 above, and 0.52 g of tris(acetylacetonato)iridium(III) were put in a reaction container provided with a three-way cock, and the air in the reaction container was replaced with argon. Then, the mixture was heated at 250° C. for 49 hours to be reacted. The reactant was dissolved in dichloromethane, and this solution was subjected to suction filtration in the state where Celite was spread over a piece of filer paper. The solvent of the resulting filtrate was distilled off, and purification was conducted by silica gel column chromatography which uses ethyl acetate as a developing solvent. Further, recrystallization was carried out with a mixed solvent of dichloromethane and hexane, so that the organometallic complex [Ir(Ftaz)₃] which is one embodiment of the present invention was prepared (yellow powder, yield: 76%). The synthesis scheme of Step 5 is shown by (e-1).

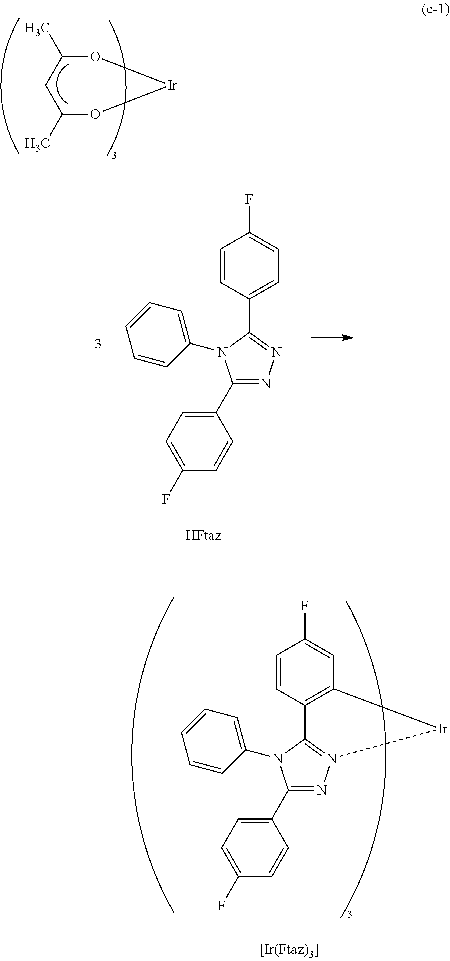

### REFERENCE EXAMPLE

In Reference Example, an example of another synthesis method of the ligand HFtaz of the organometallic complex [Ir(Ftaz)₃] which is one embodiment of the present invention represented by Structural Formula (100) in Embodiment 1, which is different from Synthesis Example 1, is specifically described.

### Synthesis of 3,5-bis(4-fluorophenyl)-4-phenyl-4H-1,2,4-triazole (abbreviation: HFtaz)

First, 1.9 g of p-toluene sulfonic acid monohydrate (abbreviation: TsOH.H₂O) and 15 mL of 1,2-dichlorobenzene were put in a 100 mL three-neck flask and mixed. Next, 2.6 g of 2,5-bis(4-fluorophenyl)-1,3,4-oxadiazole and 0.93 g of aniline were added, and heated and stirred at 150° C. for 11 hours. After the stirring, the reaction solution was cooled, and a precipitated solid was subjected to suction filtration. Recrystallization was carried out on the resulting solid with a mixed solvent of toluene and hexane, so that 3,5-bis(4-fluorophenyl)-4-phenyl-4H-1,2,4-triazole (abbreviation: HFtaz) was prepared (a white solid, yield: 53%). The synthetic scheme of this step is shown by (f-1).

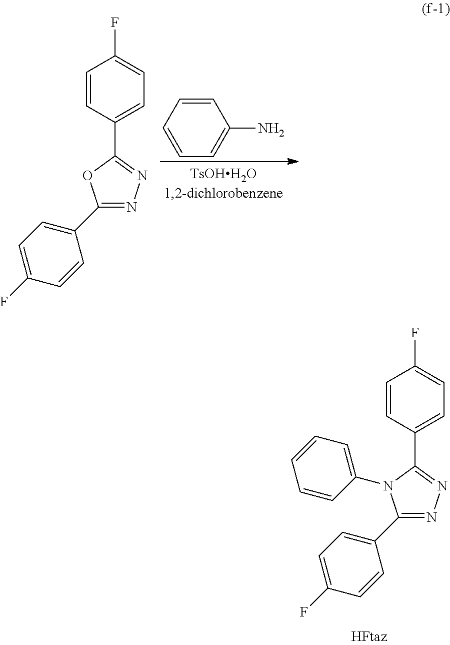

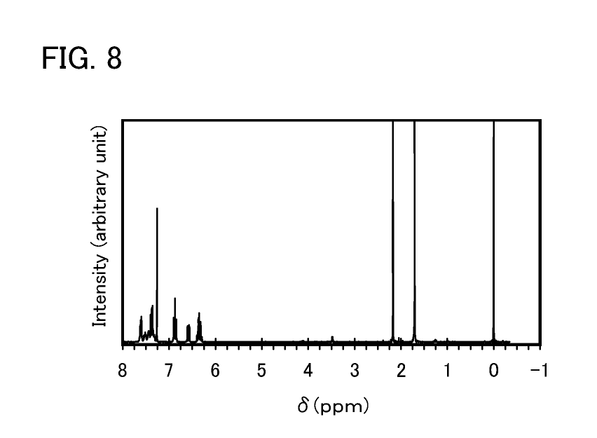

An analysis result (¹H-NMR data) by nuclear magnetic resonance spectrometry (¹H-NMR) of the yellow powder prepared in Step 5 above is shown below. In addition, FIG. 8 shows a ¹H-NMR chart. From the result, it was found that the organometallic complex [Ir(Ftaz)₃] which is one embodiment of the present invention represented by Structural Formula (100) was prepared in Synthesis Example 1.

¹H-NMR. δ (CDCl₃): 6.29-6.40 (m, 6H), 6.58 (dd, 3H), 6.87 (t, 6H), 7.32-7.45 (m, 12H), 7.48-7.54 (m, 3H), 7.59-7.62 (m, 6H).

The decomposition temperature of the prepared organometallic complex [Ir(Ftaz)₃] which is one embodiment of the present invention was measured with a high vacuum differential type differential thermal balance (TG-DTA2410SA manufactured by Bruker AXS K.K.). The temperature was increased at a rate of 10° C./min; as a result, the gravity decreased by 5% at 402° C. and thus a favorable heat resistance was exhibited.

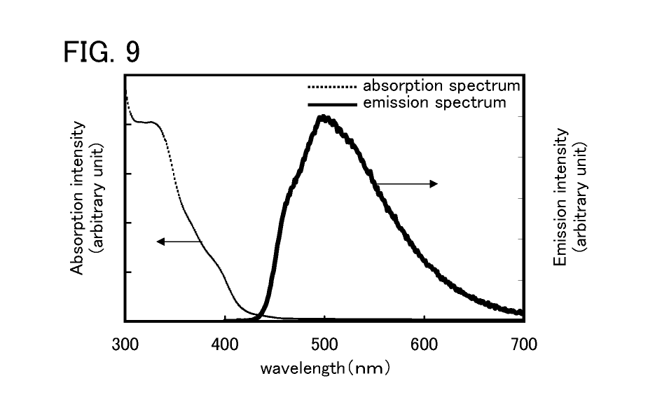

Next, [Ir(Ftaz)₃] was analyzed by an ultraviolet-visible (UV) absorption spectroscopy. The UV spectrum was measured by an ultraviolet-visible spectrophotometer (V550 manufactured by JASCO Corporation) using a dichloromethane solution (0.967 mmol/L) at room temperature. Further, an emission spectrum of [Ir(Ftaz)₃] was measured. The measurement of the emission spectrum was conducted by a fluorescence spectrophotometer (FS920 manufactured by Hamamatsu Photonics Corporation) using a degassed dichloromethane solution (0.967 mmol/L) at room temperature. FIG. 9 shows the measurement results. In FIG. 9, the horizontal axis represents wavelength and the vertical axis represents absorption intensity and emission intensity.

As shown in FIG. 9, the organometallic complex [Ir(Ftaz)₃] which is one embodiment of the present invention has a peak of emission at 499 nm, and green light was observed from the dichloromethane solution.

### COMPARATIVE EXAMPLE 1

### SYNTHESIS EXAMPLE 2

In Synthesis Example 2, a synthesis example of tris [4-(2,6-dimethylphenyl)-3,5-diphenyl-4H-1,2,4-triazolato]iridium(III) (abbreviation: [Ir(taz-dmp)₃]) is specifically described. Note that a structure of [Ir(taz-dmp)₃] is shown below.

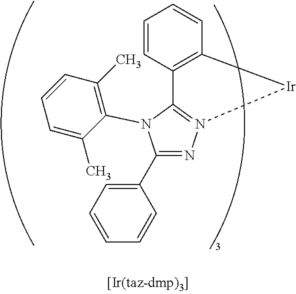

### Step 1: Synthesis of N,N′-dibenzoylhydrazine

First, 6.6 g of benzoylhydrazine and 50 mL of N-methyl-2-pyrrolidone (abbreviation: NMP) were put in a 200 mL three-neck flask and stirred. Then, a mixed solution of 5 mL of benzoyl chloride and 10 mL of NMP was dripped to the above mixed solution through a 50 mL dropping funnel, and stirred at room temperature for 1 hour. After the stirring, the reacted mixed solution was added to 250 mL of water, and a white solid was precipitated. The precipitated solid was washed with 1M hydrochloric acid and subjected to suction filtration to give a white solid. The given solid was washed with methanol, so that N,N′-dibenzoylhydrazine was prepared (a white solid, yield: 65%). The synthesis scheme of Step 1 is shown by (a-2).

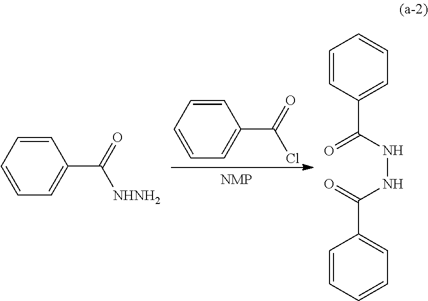

### Step 2: Synthesis of 1,2-di[chloro(phenyl)methylidene]hydrazine

Next, 7.5 g of N,N′-dibenzoylhydrazine that was prepared in Step 1 above and 100 mL of toluene were put in a 300 mL three-neck flask and stirred. Then, 13 g of phosphorus pentachloride was added to this mixed solution, and heated and stirred at 110° C. for 4 hours. After the stirring, the reaction solution was added to 250 mL of water and stirred for 1 hour. After the stirring, an organic layer and an aqueous layer were separated, and the organic layer was washed with water and then a saturated aqueous solution of sodium hydrogen carbonate. After the washing, anhydrous magnesium sulfate was added to the organic layer for drying. The resulting mixture was subjected to gravity filtration, and the filtrate was concentrated to give a solid. This solid was washed with methanol, so that 1,2-di[chloro(phenyl)methylidene]hydrazine was prepared (a yellow solid, yield: 82%). The synthetic scheme of Step 2 is shown by (b-2).

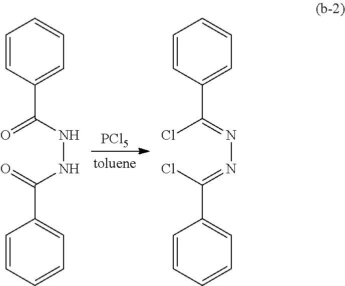

### Step 3: Synthesis of 4-(2,6-dimethylphenyl)-3,5-diphenyl-4H-1,2,4-triazole (abbreviation: Htaz-dmp)

First, 4.0 g of 1,2-di[chloro(phenyl)methylidene]hydrazine prepared in Step 2 above, 40 mL of dimethylaniline, and 2 mL of 2,6-dimethylaniline were put in a 200 mL recovery flask, and were heated and stirred at 120° C. for 28 hours. This reaction solution was added to 100 mL of 1M hydrochloric acid and stirred, whereby a solid was precipitated. This solid was subjected to suction filtration to give a yellow solid. The given solid was purified by silica gel column chromatography. A mixed solvent of toluene:ethyl acetate=1:1 was used as a developing solvent. The resulting fraction was condensed to give a solid. Further, recrystallization was carried out with a mixed solvent of hexane and ethanol, so that 4-(2,6-dimethylphenyl)-3,5-diphenyl-4H-1,2,4-triazole was prepared (a white solid, yield: 50%). The synthetic scheme of Step 3 is shown by (c-2).

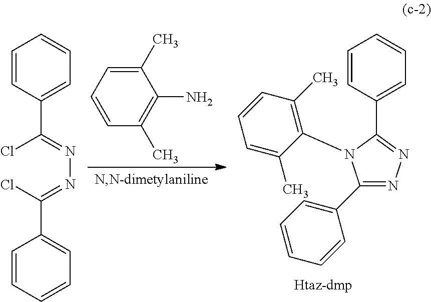

### Step 4: Synthesis of tris[4-(4-tert-butylphenyl)-3,5-diphenyl-4H-1,2,4-triazolato]iridium(III) (abbreviation: [Ir(taz-dmp)₃])

Further, 0.82 g of the ligand Htaz-dmp prepared in Step 4 above and 0.25 g of tris(acetylacetonato)iridium(III) were put in a reaction container provided with a three-way cock, and the air in the reaction container was replaced with argon. Then, the mixture was heated at 250° C. for 48 hours to be reacted. The reactant was dissolved in dichloromethane, and this solution was subjected to suction filtration in the state where Celite was spread over a piece of filer paper. The solvent of the resulting filtrate was distilled off and purification was conducted by silica gel column chromatography which uses ethyl acetate as a developing solvent. Further, recrystallization was carried out with ethyl acetate, so that [Ir(taz-dmp)₃] was prepared (yellow powder, yield: 38%). The synthetic scheme of Step 4 is shown by (d-2).

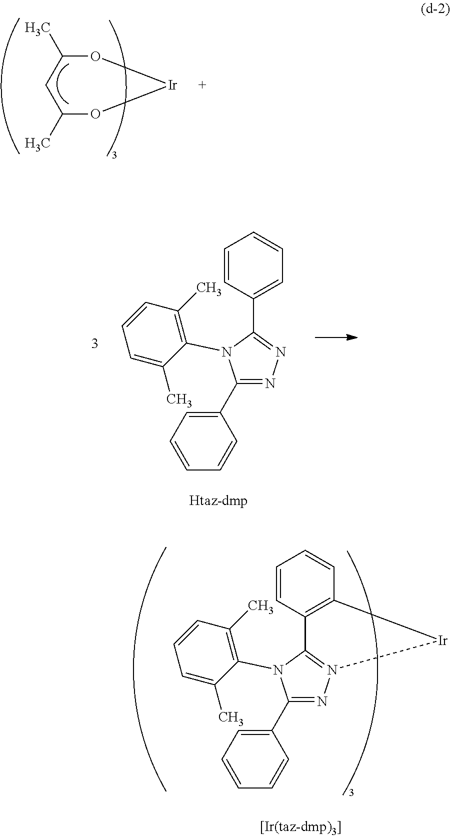

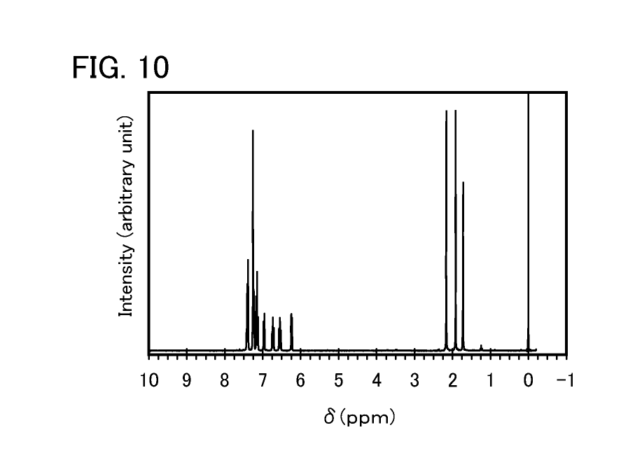

An analysis result (¹H-NMR data) by nuclear magnetic resonance spectrometry (¹H-NMR) of the yellow powder prepared in Step 4 above is shown below. In addition, FIG. 10 shows a ¹H-NMR chart. From the result, it was found that [Ir(taz-dmp)₃] was prepared in Comparative Example 1.

¹H-NMR. δ (CDCl₃): 1.92 (s, 3H), 2.16 (s, 3H), 6.24 (d, 1H), 6.55 (t, 1H), 6.73 (t, 1H), 6.96 (d, 1H), 7.15 (t, 2H), 7.22-7.27 (m, 3H), 7.38-7.43 (m, 3H).

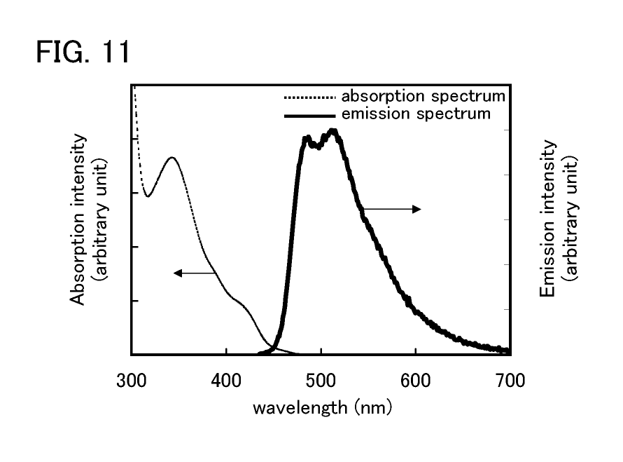

Next, [Ir(taz-dmp)₃] was analyzed by an ultraviolet-visible (UV) absorption spectroscopy. The UV spectrum was measured by an ultraviolet-visible spectrophotometer (V550 manufactured by JASCO Corporation) using a dichloromethane solution (0.558 mmol/L) at room temperature. Further, an emission spectrum of [Ir(taz-dmp)₃] was measured. The measurement of the emission spectrum was conducted by a fluorescence spectrophotometer (FS920 manufactured by Hamamatsu Photonics Corporation) using a degassed dichloromethane solution (0.558 mmol/L) at room temperature. FIG. 11 shows the measurement results. In FIG. 11, the horizontal axis represents wavelength and the vertical axis represents absorption intensity and emission intensity.

As shown in FIG. 11, [Ir(taz-dmp)₃] has peaks of emission at 486 nm and 511 nm, and green light was observed from the dichloromethane solution.

### COMPARATIVE EXAMPLE 2

### SYNTHESIS EXAMPLE 3

In Synthesis Example 3, a synthesis example of tris[3,5-bis(4-tert-butylphenyl)-4-phenyl-4H-1,2,4-triazolato]iridium(III) (abbreviation: [Ir(tButaz)₃]) is specifically described. Note that a structure of [Ir(tButaz)₃] is shown below.

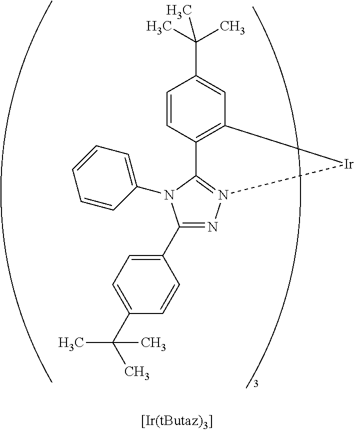

### Synthesis of tris[3,5-bis(4-tert-butylphenyl)-4-phenyl-4H-1,2,4-triazolato]iridium(III) (abbreviation: [Ir(tButaz)₃])

First, 1.41 g of the ligand 3,5-bis(4-tert-butylphenyl)-4-phenyl-4H-1,2,4-triazole (abbreviation: HtButaz) and 0.34 g of tris(acetylacetonato)iridium(III) were put in a reaction container provided with a three-way cock, and the air in the reaction container was replaced with argon. Then, the mixture was heated at 250° C. for 43 hours to be reacted. The reactant was dissolved in dichloromethane, and this solution was subjected to suction filtration in the state where Celite was spread over a piece of filer paper. The solvent of the resulting filtrate was distilled off and recrystallization was carried out with ethyl acetate, so that [Ir(tButaz)₃] was prepared (yellow powder, yield: 68%). The synthesis scheme is shown by (a-3).

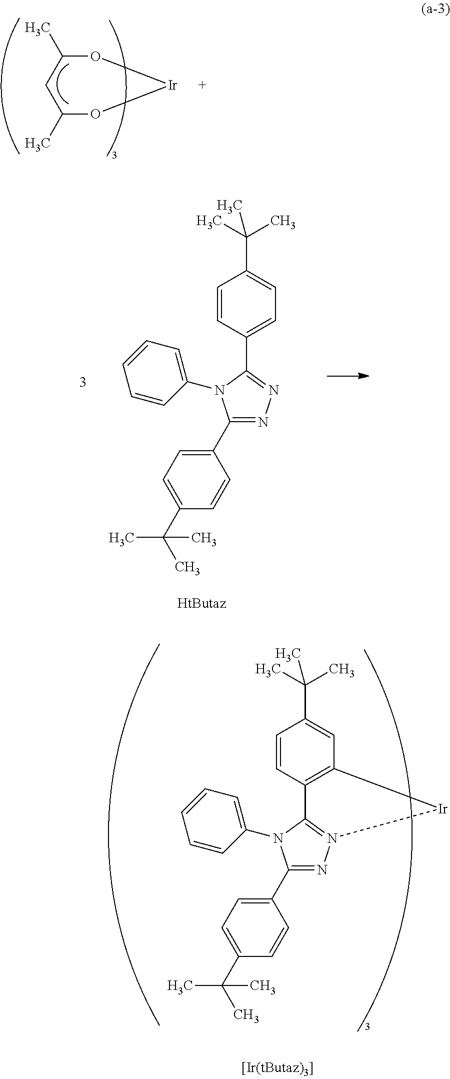

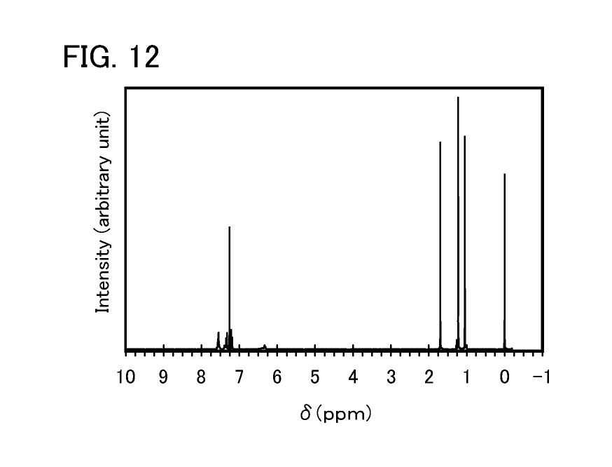

An analysis result (¹H-NMR data) by nuclear magnetic resonance spectrometry (¹H-NMR) of the yellow powder prepared in the above synthesis is shown below. In addition, FIG. 12 shows a ¹H-NMR chart. From the result, it was found that [Ir(tButaz)₃] was prepared in Comparative Example 2.

¹H-NMR. δ (CDCl₃): 1.05 (s, 18H), 1.22 (s, 18H), 6.34 (m, 6H), 7.21 (d, 6H), 7.35 (m, 9H), 7.55 (m, 15H).

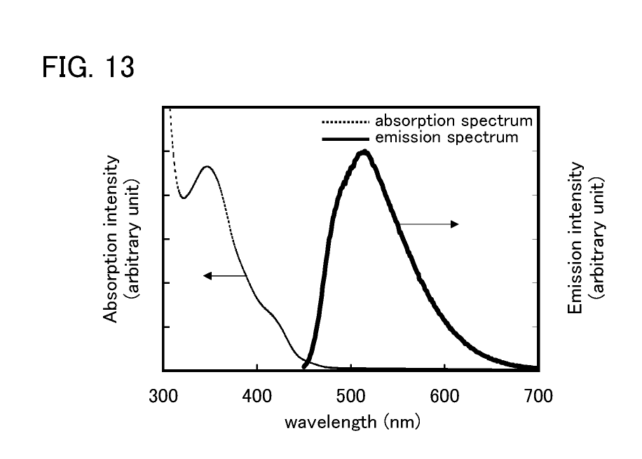

Next, [Ir(tButaz)₃] was analyzed by an ultraviolet-visible (UV) absorption spectroscopy. The UV spectrum was measured by an ultraviolet-visible spectrophotometer (V550 manufactured by JASCO Corporation) using a dichloromethane solution (0.078 mmol/L) at room temperature. Further, an emission spectrum of [Ir(tButaz)₃] was measured. The measurement of the emission spectrum was conducted by a fluorescence spectrophotometer (FS920 manufactured by Hamamatsu Photonics Corporation) using a degassed dichloromethane solution (0.47 mmol/L) at room temperature. FIG. 13 shows the measurement results. In FIG. 13, the horizontal axis represents wavelength and the vertical axis represents absorption intensity and emission intensity.

As shown in FIG. 13, [Ir(tButaz)₃] has a peak of emission at 515 nm, and green light was observed from the dichloromethane solution.

### COMPARATIVE EXAMPLE 3

### SYNTHESIS EXAMPLE 4

In Synthesis Example 4, a synthesis example of (acetylacetonato)bis[3,5-bis(4-fluorophenyl)-4-phenyl-4H-1,2,4-triazolato]iridium(III) (abbreviation: [Ir(Ftaz)₂(acac)]) is specifically described. Note that a structure of [Ir(Ftaz)₂(acac)] is shown below.

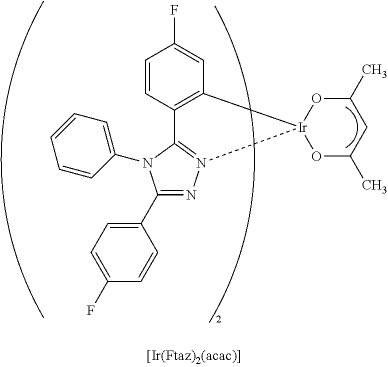

### Step 1: Synthesis of di-μ-chloro-bis{bis[3,5-bis(4-fluorophenyl)-4-phenyl-4H-1,2,4-triazolato]}iridium(III) (abbreviation: [Ir(Ftaz)₂Cl]₂)

First, 15 mL of 2-ethoxyethanol, 5 mL of water, 1.23 g of the ligand HFtaz prepared according to the method in Synthesis Example 1, and 0.50 g of iridium chloride hydrate (IrCl₃.nH₂O) were put in a recovery flask equipped with a reflux pipe, and the air in the flask was replaced with argon. Then, irradiation with microwaves (2.45 GHz, 100 W) for 30 minutes was performed to cause reaction. The reaction solution was filtrated and the residue was washed with ethanol, so that a binuclear complex [Ir(Ftaz)₂Cl]₂ was prepared as yellow powder (yield: 28%). Note that the irradiation with microwaves was performed using a microwave synthesis system (Discover manufactured by CEM Corporation). The synthetic scheme of Step 1 is shown by (a-4).

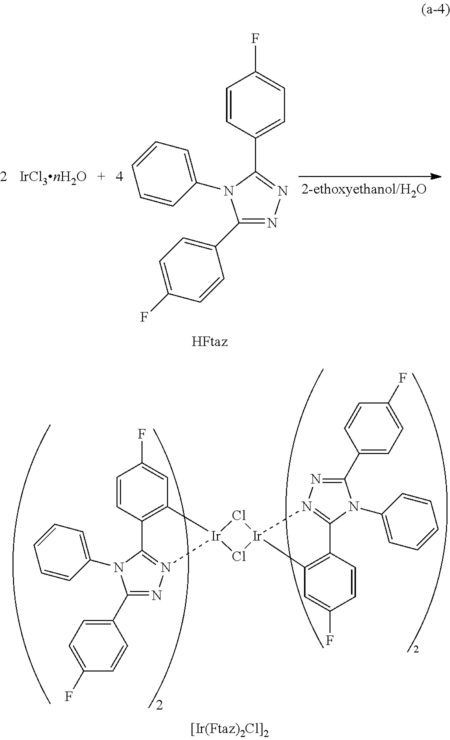

### Step 2: Synthesis of (acetylacetonato)bis[3,5-bis(4-fluorophenyl)-4-phenyl-4H-1,2,4-triazolato]iridium(III) (abbreviation: [Ir(Ftaz)₂(acac)])

Further, 20 mL of 2-ethoxyethanol, 0.43 g of the binuclear complex [Ir(Ftaz)₂Cl]₂ prepared in Step 1 above, 0.074 mL of acetylacetone (abbreviation: Hacac), and 0.25 g of sodium carbonate were put in a recovery flask equipped with a reflux pipe, and the air in the flask was replaced with argon. Then, irradiation with microwaves (2.45 GHz, 100 W) for 30 minutes was performed to cause reaction. The reaction solution was concentrated and dried, and the given residue was dissolved in ethyl acetate and filtrated. The resulting filtrate was concentrated and dried, and recrystallization was carried out on the residue with methanol, so that [Ir(Ftaz)₂(acac)] was prepared as yellow powder (yield: 25%). The synthetic scheme of Step 2 is shown by (b-4).

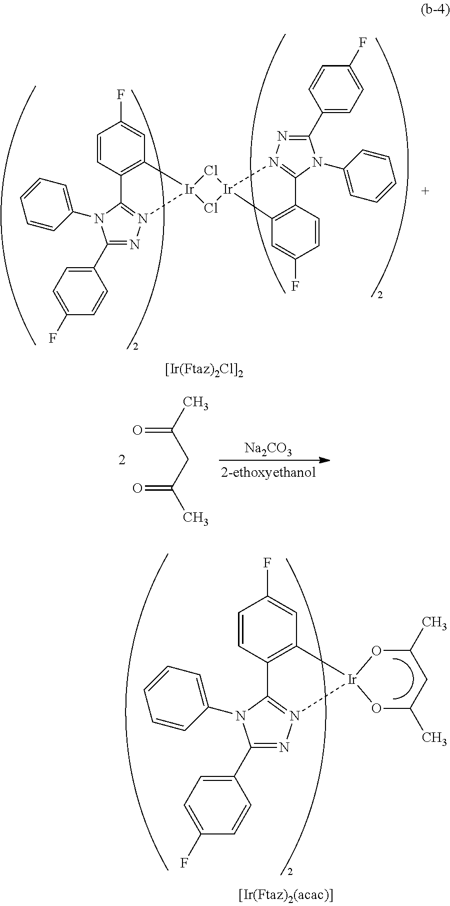

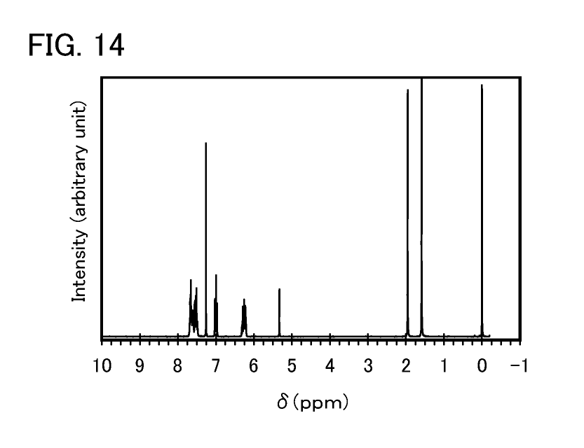

An analysis result (¹H-NMR data) by nuclear magnetic resonance spectrometry (¹H-NMR) of the yellow powder prepared in Step 2 above is shown below. In addition, FIG. 14 shows a ¹H-NMR chart. From the result, it was found that [Ir(Ftaz)₂(acac)] was prepared in Synthesis Example 4.

¹H-NMR. δ (CDCl₃): 1.96 (s, 6H), 5.33 (s, 1H), 6.20-6.32 (m, 6H), 7.00 (t, 4H), 7.49-7.56 (m, 6H), 7.58-7.69 (m, 8H).

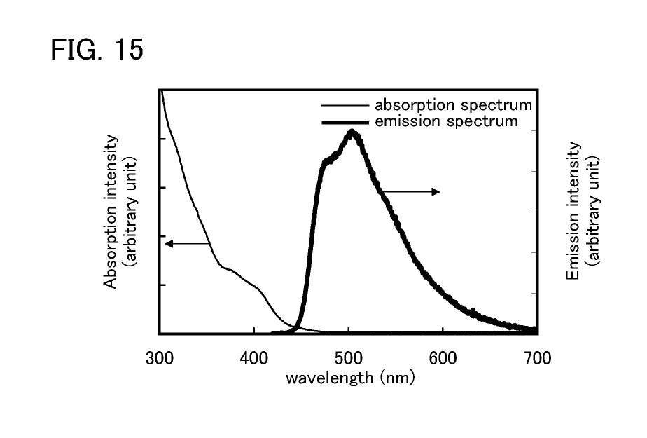

Next, [Ir(Ftaz)₂(acac)] was analyzed by an ultraviolet-visible (UV) absorption spectroscopy. The UV spectrum was measured by an ultraviolet-visible spectrophotometer (V550 manufactured by JASCO Corporation) using a dichloromethane solution (0.051 mmol/L) at room temperature. Further, an emission spectrum of [Ir(Ftaz)₂(acac)] was measured. The measurement of the emission spectrum was conducted by a fluorescence spectrophotometer (FS920 manufactured by Hamamatsu Photonics Corporation) using a degassed dichloromethane solution (0.30 mmol/L) at room temperature. FIG. 15 shows the measurement results. In FIG. 15, the horizontal axis represents wavelength and the vertical axis represents absorption intensity and emission intensity.

As shown in FIG. 15, [Ir(Ftaz)₂(acac)] has a peak of emission at 504 nm, and green light was observed from the dichloromethane solution.

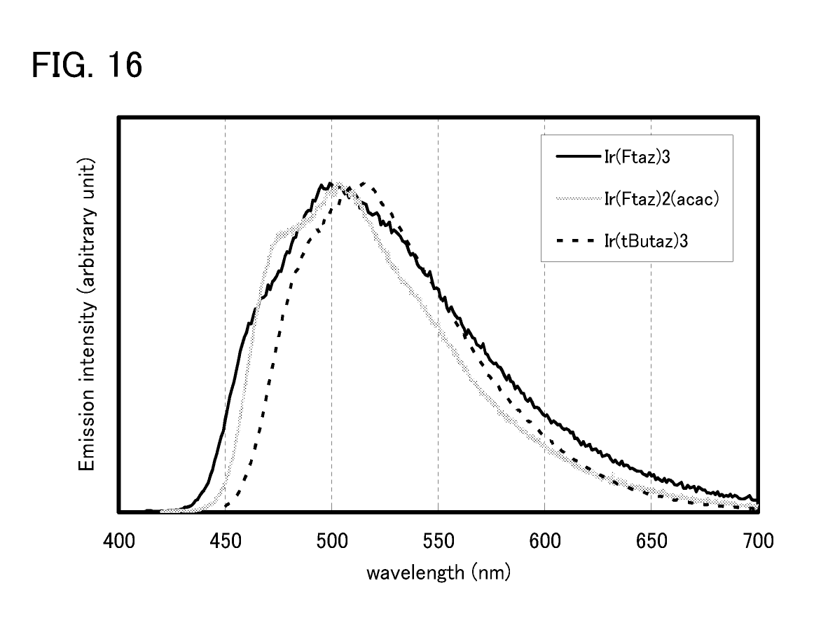

FIG. 16 shows comparison between emission spectra of the organometallic complex [Ir(Ftaz)₃] which is one embodiment of the present invention represented by Structural Formula (100) in Embodiment 1, the organometallic complex [Ir(tButaz)₃] of Comparative Example 2, and the organometallic complex [Ir(Ftaz)₂(acac)] of Comparative Example 3. The respective measurement results correspond to FIG. 9, FIG. 13, and FIG. 15.

From comparison between the emission spectra of [Ir(Ftaz)₃] and [Ir(Ftaz)₂(acac)] in FIG. 16, it is found that [Ir(Ftaz)₃] emits light having a wider region in both a long wavelength region and a short wavelength region.

In addition, from comparison between the emission spectra of [Ir(tButaz)₃] and [Ir(Ftaz)₃] in FIG. 16, although the peak of emission of [Ir(Ftaz)₃] is in a shorter wavelength region than that of [Ir(tButaz)₃], it is found that [Ir(Ftaz)₃] has higher emission intensity than [Ir(tButaz)₃] in a wavelength region that is longer than the wavelength region of the peak of emission of [Ir(tButaz)₃].

Therefore, it is found that [Ir(Ftaz)₃] exhibits a broad emission spectrum as compared to [Ir(Ftaz)₂(acac)] and [Ir(tButaz)₃]. That is, it is found that [Ir(Ftaz)₃] is an organometallic complex that emits light in a wider wavelength band of green to blue than [Ir(Ftaz)₂(acac)] and [Ir(tButaz)₃].

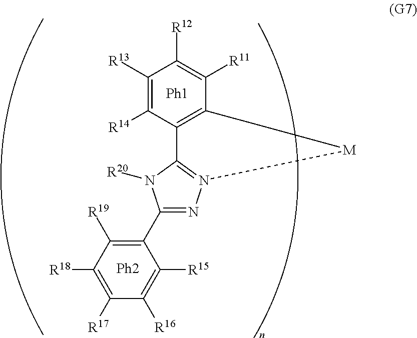

Further, the comparison between the emission spectra in FIG. 16 can generate the following discussion with reference to the above complex G7.

By having substituents formed using electron-withdrawing groups in R¹² and R¹⁷, the complex G7 is a phosphorescent material that emits light in a wider wavelength band of green to blue. This can be explained as follows.

When R¹² is an electron-withdrawing group, an electron (mainly a π-electron) of a benzene ring Ph1 is drawn to R¹² and an electron is easily donated from a metal M. That is, charge is easily transferred from the metal M to a ligand (mainly the benzene ring Ph1) (i.e., MLCT transition easily occurs) as compared to the case where R¹² is not an electron-withdrawing group, and at the same time, even when the electron is drawn to be sufficiently close to R¹², the electron still exists in the benzene ring Ph1. Therefore, considering inductive effects, the energy state of the entire complex G7 is made unstable.

In particular, in the case of an electron-withdrawing group whose electron-withdrawing property is not relatively high, such as a fluoro group, even when the complex G7 is brought into an MLCT transition state, an electron in the benzene ring Ph1 is not drawn closely enough by the fluoro group, and an electron is donated from the metal M to the benzene ring Ph1. Therefore, the energy state of the entire complex G7 becomes unstable.

In contrast, in the case where R¹⁷ is an electron-withdrawing group, an electron (mainly a π-electron) in a benzene ring Ph2 is drawn to R¹⁷, and the benzene ring Ph2 is made inactivated. In addition, an electron (mainly a π-electron) in the benzene ring Ph2 is drawn also to a triazole ring. Therefore, considering inductive effects, the benzene ring Ph2 becomes stable. As a result, the energy state of the entire complex G7 is made stable.

As described above, from discussion in terms of electronic theory of organic chemistry, by including substituents formed using electron-withdrawing groups in at least R¹² and R¹⁷, R¹² contributes to unstabilization of the energy state of the entire complex G7, and R¹⁷ contributes to stabilization of the energy state of the entire complex G7. Due to this, it is assumed that the complex exhibits phosphorescence in a wider emission spectrum in a wavelength band of green to blue.

Therefore, by including substituents formed using electron-withdrawing groups in at least R¹² and R¹⁷, it is possible to provide a phosphorescent material that emits light in a wider wavelength band of green to blue.

Note that the electron-withdrawing group can be a group of atoms by which an electron is drawn by resonance effects, inductive effects, or the like, such as a halogen group, a haloalkyl group, or a cyano group.

### EXAMPLE 2

In Example 2, a light-emitting element (referred to as “Light-emitting element 1” below) including the organometallic complex [Ir(Ftaz)₃] represented by Structural Formula (100) in Embodiment 1 is described. Structural formulas of part of materials used in Example 2 are shown below.

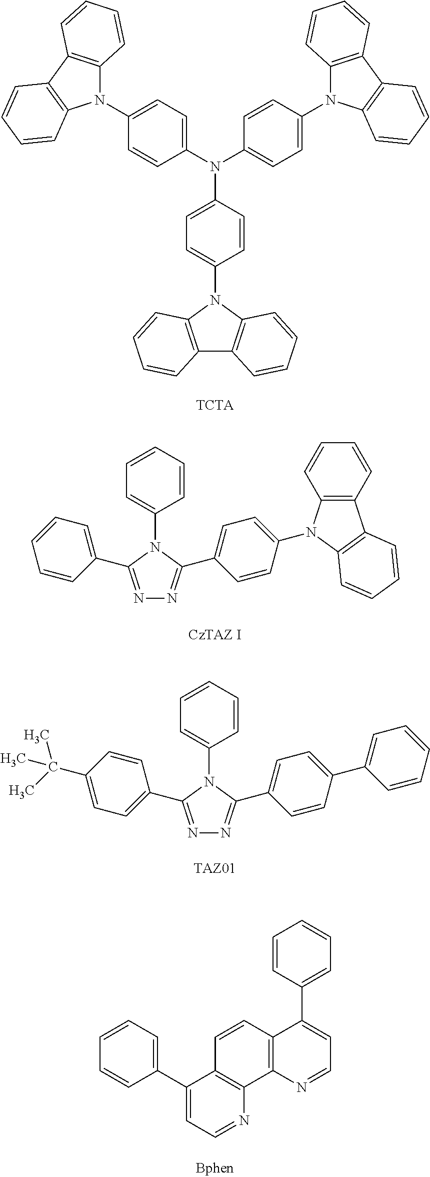

### (Light-Emitting Element 1)

First, over a glass substrate, indium tin oxide containing silicon oxide was deposited by a sputtering method, so that a first electrode which functions as an anode was formed. The thickness of the first electrode was 110 nm and the electrode area was 2 mm×2 mm

Next, the glass substrate over which the first electrode was formed was fixed to a substrate holder provided in a vacuum evaporation apparatus such that the side on which the first electrode was formed faced downward, and the pressure was reduced to approximately 10⁻⁴ Pa. After that, over the first electrode, a layer containing a composite material of an organic compound and an inorganic compound was formed by co-evaporation of 4,4′,4″-tris(N-carbazolyl)triphenylamine (abbreviation: TCTA) and molybdenum(VI) oxide. The thickness of the layer containing a composite material was 50 nm, and the weight ratio of TCTA and molybdenum oxide was adjusted to 2:1 (=TCTA:molybdenum oxide). Note that the co-evaporation method means an evaporation method in which evaporation of a plurality of materials is performed using a plurality of evaporation sources at the same time in one treatment chamber.

Next, a 10-nm-thick TCTA layer was formed over the layer containing a composite material by an evaporation method using resistance heating, so that a hole-transport layer was formed.

Further, a 30-nm-thick light-emitting layer was formed over the hole-transport layer by co-evaporation of 9-[4-(4,5-diphenyl-4H-1,2,4-triazol-3-yl)phenyl]-9H-carbazole (abbreviation: CzTAZ I) and [Ir(Ftaz)₃], which is the organometallic complex represented by Structural Formula (100) of Embodiment 1. Here, the weight ratio of CzTAZ I and [Ir(Ftaz)₃] was adjusted to 1:0.06 (=CzTAZ I:[Ir(Ftaz)₃]).

After that, over the light-emitting layer, a 10-nm-thick 3-(4-tert-butylphenyl)-4-phenyl-5-(4-biphenylyl)-1,2,4-triazole (abbreviation: TAZ 01) layer was formed by an evaporation method using resistance heating, and then a 20-nm-thick bathophenanthroline (abbreviation: BPhen) layer was formed by an evaporation method using resistance heating. In such a manner, an electron-transport layer in which a layer formed using TAZ 01 and a layer formed using BPhen are stacked was formed over the light-emitting layer.

Furthermore, a 1-nm-thick lithium fluoride layer was formed over the electron-transport layer, so that an electron-injection layer was formed.

Lastly, a 200-nm-thick aluminum layer was formed over the electron-injection layer by an evaporation method using resistance heating, so that a second electrode which functions as a cathode was formed. Through the above-described process, Light-emitting element 1 was fabricated.

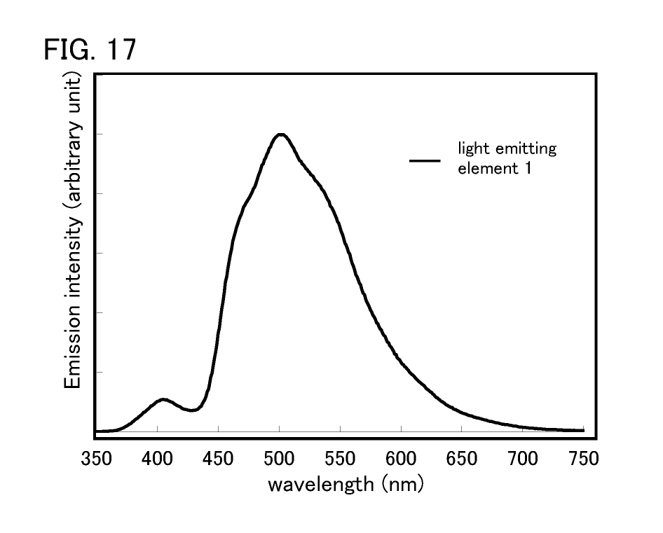

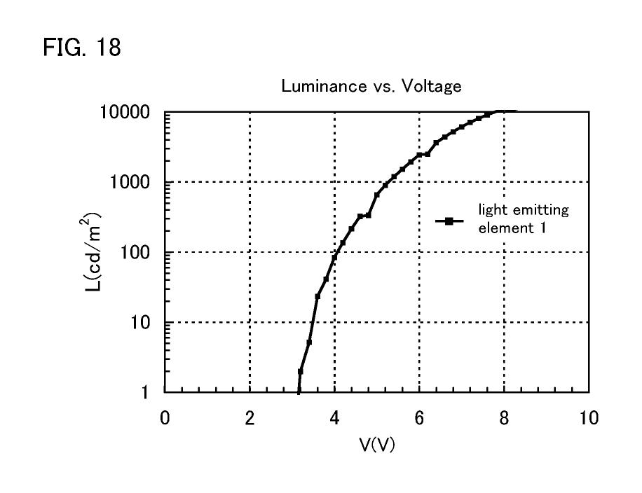

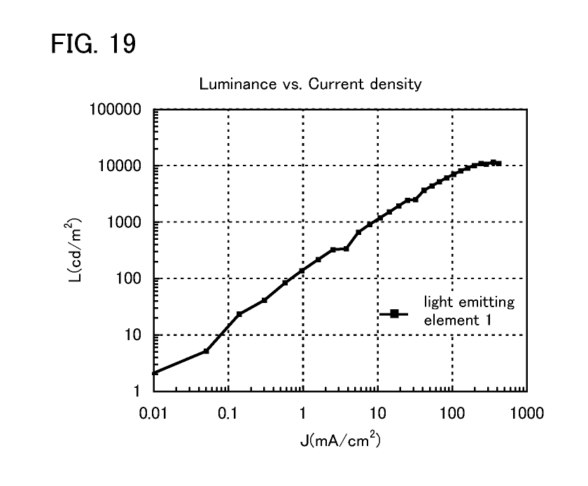

FIG. 17 shows an emission spectrum of Light-emitting element 1 at a current of 0.5 mA. FIG. 18 shows voltage vs. luminance characteristics of Light-emitting element 1. FIG. 19 shows current density vs. luminance characteristics of Light-emitting element 1. From FIG. 17, it is found that the light emission from Light-emitting element 1 originates from [Ir(Ftaz)₃]. The CIE chromaticity coordinates of Light-emitting element 1 at a luminance of 898 cd/m² are (x, y)=(0.24, 0.42), and blue-green light was emitted. As seen in FIG. 18, the driving voltage of Light-emitting element 1 at 898 cd/m² is 5.2 V, and the power efficiency is 6.91 m/W. These results indicate that Light-emitting element 1 needs a low voltage for obtaining a certain luminance, has low power consumption, and has an extremely high current efficiency and power efficiency.

This application is based on Japanese Patent Application serial no. 2010-031027 filed with Japan Patent Office on Feb. 16, 2010, the entire contents of which are hereby incorporated by reference.

What is claimed is:

1. An organometallic complex represented by formula (G1): 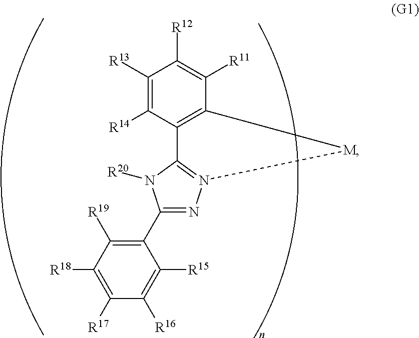
wherein at least one of R¹¹ to R¹⁴ represents any of a halogen group, a haloalkyl group having 1 to 4 carbon atoms, and a cyano group, and the other of R¹¹ to R¹⁴ represents any of hydrogen, an alkyl group having 1 to 6 carbon atoms, a cycloalkyl group having 5 to 8 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, an alkylamino group having 2 to 8 carbon atoms, and an arylamino group having 6 to 12 carbon atoms,
wherein at least one of R¹⁵ to R¹⁹ represents any of a halogen group, a haloalkyl group having 1 to 4 carbon atoms, and a cyano group, and the other of R¹⁵ to R¹⁹ represents any of hydrogen, an alkyl group having 1 to 6 carbon atoms, a cycloalkyl group having 5 to 8 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, an alkylamino group having 2 to 8 carbon atoms, and an arylamino group having 6 to 12 carbon atoms,
wherein R²⁰ represents any of an alkyl group having 1 to 6 carbon atoms, a cycloalkyl group having 5 to 8 carbon atoms, an aryl group having 6 to 12 carbon atoms, and a heteroaryl group having 4 to 10 carbon atoms,
wherein M is either a Group 9 element or a Group 10 element, and
wherein n is 3 when M is the Group 9 element or 2 when M is the Group 10 element.

2. The organometallic complex according to claim 1,
wherein the organometallic complex is represented by formula (G3): 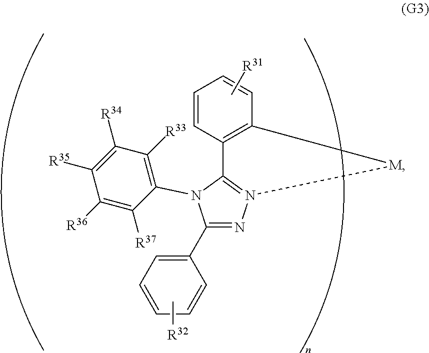
wherein each of R³¹ and R³² represents any of a halogen group, a haloalkyl group having 1 to 4 carbon atoms, and a cyano group, and
wherein each of R³³ to R³⁷ represents any of hydrogen, an alkyl group having 1 to 6 carbon atoms, a cycloalkyl group having 5 to 8 carbon atoms, and a phenyl group.

3. The organometallic complex according to claim 2, wherein R³¹ and R³² are fluoro groups.

4. The organometallic complex according to claim 1,
wherein the organometallic complex is represented by formula (G5): 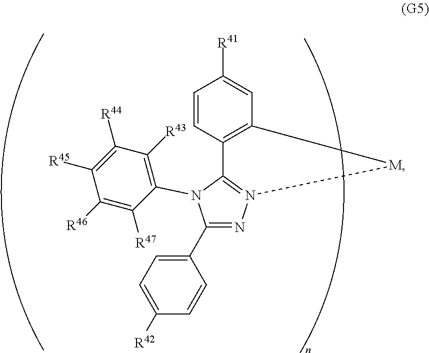
wherein each of R⁴¹ and R⁴² represents any of a halogen group, a haloalkyl group having 1 to 4 carbon atoms, and a cyano group, and
wherein each of R⁴³ to R⁴⁷ represents any of hydrogen, an alkyl group having 1 to 6 carbon atoms, a cycloalkyl group having 5 to 8 carbon atoms, and a phenyl group.

5. The organometallic complex according to claim 4, wherein R⁴¹ and R⁴² are fluoro groups.

6. The organometallic complex according to claim 1,
wherein M is iridium.

7. A light emitting element comprising:
a first electrode;
a second electrode; and
a layer including an organometallic complex, the layer interposed between the first electrode and the second electrode,
wherein the organometallic complex is represented by formula (G1): 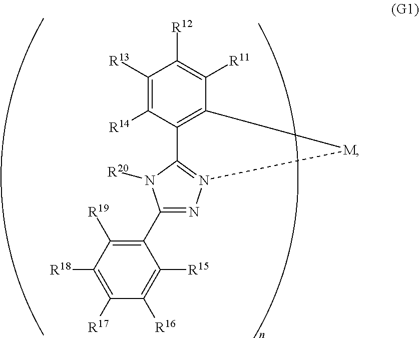
wherein at least one of R¹¹ to R¹⁴ represents any of a halogen group, a haloalkyl group having 1 to 4 carbon atoms, and a cyano group, and the other of R¹¹ to R¹⁴ represents any of hydrogen, an alkyl group having 1 to 6 carbon atoms, a cycloalkyl group having 5 to 8 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, an alkylamino group having 2 to 8 carbon atoms, and an arylamino group having 6 to 12 carbon atoms,
wherein at least one of R¹⁵ to R¹⁹ represents any of a halogen group, a haloalkyl group having 1 to 4 carbon atoms, and a cyano group, and the other of R¹⁵ to R¹⁹ represents any of hydrogen, an alkyl group having 1 to 6 carbon atoms, a cycloalkyl group having 5 to 8 carbon atoms, an alkoxy group having 1 to 6 carbon atoms, an aryloxy group having 6 to 12 carbon atoms, an alkylthio group having 1 to 6 carbon atoms, an arylthio group having 6 to 12 carbon atoms, an alkylamino group having 2 to 8 carbon atoms, and an arylamino group having 6 to 12 carbon atoms,
wherein R²⁰ represents any of an alkyl group having 1 to 6 carbon atoms, a cycloalkyl group having 5 to 8 carbon atoms, an aryl group having 6 to 12 carbon atoms, and a heteroaryl group having 4 to 10 carbon atoms,
wherein M is either a Group 9 element or a Group 10 element, and
wherein n is either 3 when M is the Group 9 element or 2 when M is the Group 10 element.

8. The light emitting element according to claim 7,
wherein the organometallic complex is represented by formula (G3): 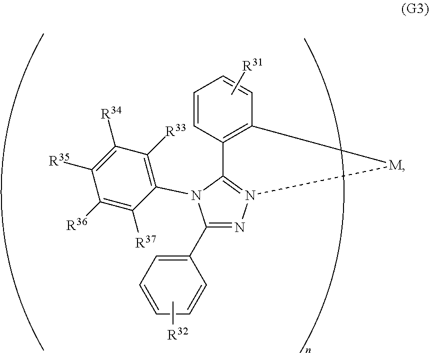
wherein each of R³¹ and R³² represents any of a halogen group, a haloalkyl group having 1 to 4 carbon atoms, and a cyano group, and
wherein each of R³³ to R³⁷ represents any of hydrogen, an alkyl group having 1 to 6 carbon atoms, a cycloalkyl group having 5 to 8 carbon atoms, and a phenyl group.

9. The light emitting element according to claim 8, wherein R³¹ and R³² are fluoro groups.

10. The light emitting element according to claim 7,
wherein the organometallic complex is represented by formula (G5): 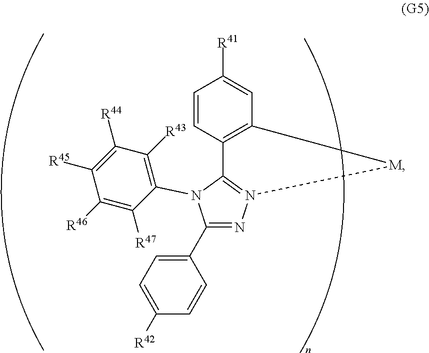
wherein each of R⁴¹ and R⁴² represents any of a halogen group, a haloalkyl group having 1 to 4 carbon atoms, and a cyano group,
wherein each of R⁴³ to R⁴⁷ represents any of hydrogen, an alkyl group having 1 to 6 carbon atoms, a cycloalkyl group having 5 to 8 carbon atoms, and a phenyl group, and
wherein M is either a Group 9 element or a Group 10 element.

11. The light emitting element according to claim 10,
wherein R⁴¹ and R⁴² are fluoro groups.

12. The light emitting element according to claim 7,
wherein M is iridium.

13. The light emitting element according to claim 7,
wherein the layer is a light emitting layer.

14. The light emitting element according to claim 7,
wherein the first electrode is over the second electrode, and
wherein a work function of a material included in the first electrode has more than or equal to 4.0 eV.

15. The light emitting element according to claim 7,
wherein the first electrode is over the second electrode, and
wherein a work function of a material included in the first electrode has more than or equal to 3.8 eV.

16. The light emitting element according to claim 7, further comprising a first light emitting unit, a second light emitting unit, and a charge generating layer,
wherein the layer is included in the first light emitting unit, and
wherein the charge generating layer is interposed between the first light emitting unit and the second light emitting unit.

17. The light emitting element according to claim 16,
wherein the second light emitting unit is configured to emit light with a longer wavelength than the first light emitting unit.

18. A lighting device comprising the light emitting element according to claim 7.

19. An electronic device comprising the light emitting element according to claim 7.
